(19) United States
(12) Patent Application Publication
(10) Pub. No.: US 2026/0303273 A1
(43) Pub. Date: Oct. 1, 2026

(54) BLOCK-FILTERED ORTHOGONAL FREQUENCY DIVISION MULTIPLEXING WITH CONFIGURABLE IDFT SIZE

(71) Applicant: QUALCOMM Incorporated, San Diego, CA (US)

(72) Inventors: Juan Carlos BUCHELI GARCIA, Marseille (FR); Mehmet Izzet GURELLI, San Diego, CA (US); Karthik ANANTHA SWAMY, La Jolla, CA (US); Qiang WU, San Diego, CA (US)

(21) Appl. No.: 19/090,222

(22) Filed: Mar. 25, 2025

(51) Int. Cl. H04L 5/00

(52) U.S. Cl. CPC H04L 5/001; H04L 5/0053

(57) ABSTRACT

Aspects relate to an inverse discrete Fourier transform (IDFT) size that is based on a power-of-two. In some examples, a first apparatus may send an indication of an IDFT size to a second apparatus. In some examples, the first apparatus and/or the second apparatus may output (e.g., transmit) or obtain (e.g., receive) a transmission based on the IDFT size. In some examples, the first apparatus and/or the second apparatus may generate the transmission based on a circular shift, within a frequency allocation, of successive resource block inputs for an IDFT.

### TECHNICAL FIELD

The technology discussed below relates generally to wireless communication and, more particularly, to block-filtered orthogonal frequency division multiplexing (BF-OFDM) techniques.

### INTRODUCTION

Some types of wireless communication systems support communication with multiple users. For example, a base station that is connected to a network may serve (e.g., provide access to the network and/or other service for) wireless communication devices (e.g., a user equipment (UE)) operating within a cell of the base station. To this end, the base station may schedule wireless communication access within the cell by, for example, allocating different resources (e.g., time domain and frequency domain resources) that different UEs operating within the cell can use to transmit and receive wireless signals.

Other types of wireless communication systems may operate in a similar manner where a first wireless communication device connected to a network provides network access and/or other service for other wireless communication devices within a coverage area of the first wireless communication device. For example, a satellite that connects to a terrestrial network (e.g., via a ground-based gateway) may serve UEs that are within the wireless communication coverage area of the satellite.

### BRIEF SUMMARY OF SOME EXAMPLES

The following presents a summary of one or more aspects of the present disclosure, in order to provide a basic understanding of such aspects. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in a form as a prelude to the more detailed description that is presented later.

In some examples, a first apparatus for communication may include a processing system. The processing system may be configured to output a first indication of an inverse discrete Fourier transform (IDFT) size, the IDFT size being based on a power-of-two. The processing system may also be configured to output or obtain a first transmission based on the IDFT size.

In some examples, a method for communication at a first apparatus is disclosed. The method may include outputting a first indication of an inverse discrete Fourier transform (IDFT) size, the IDFT size being based on a power-of-two. The method may also include outputting or obtaining a first transmission based on the IDFT size.

In some examples, a first apparatus for communication may include means for outputting a first indication of an inverse discrete Fourier transform (IDFT) size, the IDFT size being based on a power-of-two. The first apparatus may also include means for outputting or obtaining a first transmission based on the IDFT size.

In some examples, a non-transitory computer-readable medium has stored therein instructions executable by a processing system of a first apparatus to output a first indication of an inverse discrete Fourier transform (IDFT) size, the IDFT size being based on a power-of-two. The computer-readable medium may also have stored therein instructions executable by the processing system of the first apparatus to output or obtain a first transmission based on the IDFT size.

In some examples, a wireless node (e.g., a network entity) may include at least one transceiver and a processing system. The processing system may be configured to transmit, via the at least one transceiver, a first indication of an inverse discrete Fourier transform (IDFT) size, the IDFT size being based on a power-of-two. The processing system may also be configured to transmit or receive, via the at least one transceiver, a first transmission based on the IDFT size.

In some examples, a first apparatus for communication may include a processing system. The processing system may be configured to obtain a first indication of an inverse discrete Fourier transform (IDFT) size, the IDFT size being based on a power-of-two. The processing system may also be configured to obtain or output a first transmission based on the IDFT size.

In some examples, a method for communication at a first apparatus is disclosed. The method may include obtaining a first indication of an inverse discrete Fourier transform (IDFT) size, the IDFT size being based on a power-of-two. The method may also include obtaining or outputting a first transmission based on the IDFT size.

In some examples, a first apparatus for communication may include means for obtaining a first indication of an inverse discrete Fourier transform (IDFT) size, the IDFT size being based on a power-of-two. The first apparatus may also include means for obtaining or outputting a first transmission based on the IDFT size.

In some examples, a non-transitory computer-readable medium has stored therein instructions executable by a processing system of a first apparatus to obtain a first indication of an inverse discrete Fourier transform (IDFT) size, the IDFT size being based on a power-of-two. The computer-readable medium may also have stored therein instructions executable by the processing system of the first apparatus to obtain or output a first transmission based on the IDFT size.

In some examples, a wireless node (e.g., a user equipment) may include at least one transceiver and a processing system. The processing system may be configured to receive, via the at least one transceiver, a first indication of an inverse discrete Fourier transform (IDFT) size, the IDFT size being based on a power-of-two. The processing system may also be configured to receive or transmit, via the at least one transceiver, a first transmission based on the IDFT size.

These and other aspects of the disclosure will become more fully understood upon a review of the detailed description, which follows. Other aspects, features, and examples of the present disclosure will become apparent to those of ordinary skill in the art, upon reviewing the following description of specific, example aspects of the present disclosure in conjunction with the accompanying figures. While features of the present disclosure may be discussed relative to certain examples and figures below, all examples of the present disclosure can include one or more of the advantageous features discussed herein. In other words, while one or more examples may be discussed as having certain advantageous features, one or more of such features may also be used in accordance with the various examples of the disclosure discussed herein. In similar fashion, while example aspects may be discussed below as device, system, or method examples it should be understood that such example aspects can be implemented in various devices, systems, and methods.

### BRIEF DESCRIPTION OF THE DRAWINGS

FIG. 1 is a schematic illustration of a wireless communication system according to some aspects.

FIG. 2 is a schematic illustration of another wireless communication system according to some aspects.

FIG. 3 is a conceptual illustration of an example of a radio access network according to some aspects.

FIG. 4 is a schematic illustration of an example of an apparatus for communication according to some aspects.

FIG. 5 is a diagram providing a high-level illustration of one example of a configuration of a disaggregated base station according to some aspects.

FIG. 6 is a schematic illustration of wireless resources in an air interface utilizing orthogonal frequency division multiplexing (OFDM) according to some aspects.

FIG. 7 is a conceptual illustration of an example of a BF-OFDM frequency domain allocation according to some aspects.

FIG. 8 is a schematic illustration of an example of a BF-OFDM transmitter according to some aspects.

FIG. 9 is a schematic illustration of an example of a BF-OFDM receiver according to some aspects.

FIG. 10 is a conceptual illustration of an example of a circular-shift-based BF-OFDM frequency domain allocation according to some aspects.

FIG. 11 is an illustration comparing different examples of BF-OFDM transmitters according to some aspects.

FIG. 12 is an illustration comparing different examples of BF-OFDM frequency allocation operations according to some aspects.

FIG. 13 is an illustration comparing different examples of BF-OFDM frequency allocation operations according to some aspects.

FIG. 14 is a signaling diagram illustrating an example of inverse discrete Fourier transform (IDFT) size related signaling according to some aspects.

FIG. 15 is a block diagram conceptually illustrating an example of a hardware implementation for an apparatus employing a processing system according to some aspects.

FIG. 16 is a flow chart illustrating an example of a communication method according to some aspects.

FIG. 17 is a block diagram conceptually illustrating an example of a hardware implementation for an apparatus employing a processing system according to some aspects.

FIG. 18 is a flow chart illustrating an example of a communication method according to some aspects.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

While aspects and examples are described in this application by illustration to some examples, those skilled in the art will understand that additional implementations and use cases may come about in many different arrangements and scenarios. Innovations described herein may be implemented across many differing platform types, devices, systems, shapes, sizes, and packaging arrangements. For example, aspects and/or uses may come about via integrated chip examples and other non-module-component based devices (e.g., end-user devices, vehicles, communication devices, computing devices, industrial equipment, retail/purchasing devices, medical devices, artificial intelligence-enabled (AI-enabled) devices, etc.). While some examples may or may not be specifically directed to use cases or applications, a wide assortment of applicability of described innovations may occur. Implementations may range a spectrum from chip-level or modular components to non-modular, non-chip-level implementations and further to aggregate, distributed, or original equipment manufacturer (OEM) devices or systems incorporating one or more aspects of the described innovations. In some practical settings, devices incorporating described aspects and features may also necessarily include additional components and features for implementation and practice of claimed and described examples. For example, transmission and reception of wireless signals necessarily includes a number of components for analog and digital purposes (e.g., hardware components including antenna, radio frequency (RF) chains, power amplifiers, modulators, buffer, processor(s), interleaver, adders/summers, etc.). It is intended that innovations described herein may be practiced in a wide variety of devices, chip-level components, systems, distributed arrangements, disaggregated arrangements (e.g., base station and/or UE), end-user devices, etc., of varying sizes, shapes, and constitution.

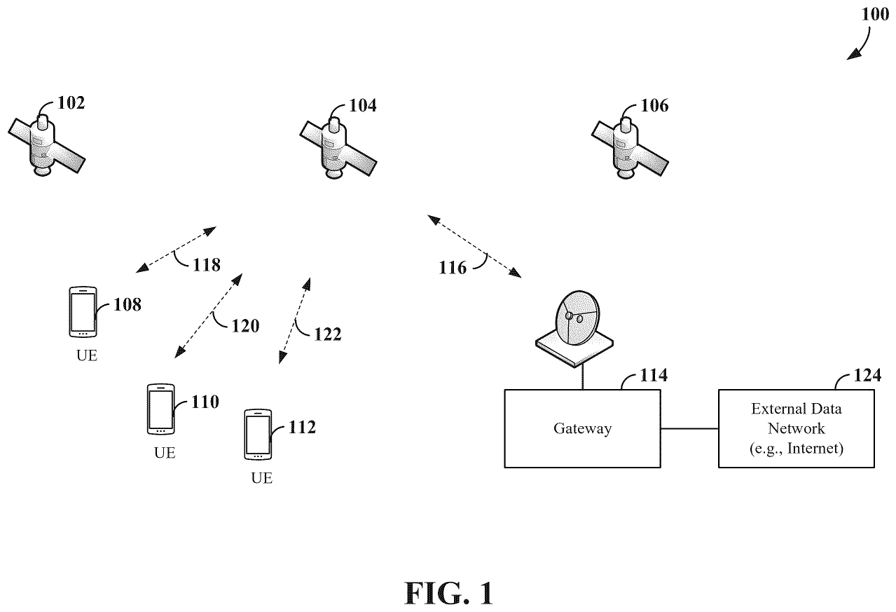

FIG. 1 illustrates an example of a satellite system 100 that includes satellites (e.g., a satellite 102, a satellite 104, a satellite 106, and so on), UEs (e.g., a UE 108, a UE 110, a UE 112, and so on), and gateways (e.g., a gateway 114). The gateway 114 is an earth station (e.g., a part of a ground network) having an antenna for transmitting signals to, and receiving signals from, communication satellites. The gateway 114 provides communication links, using the satellites, for connecting a UE to other UEs or to users of other communication systems, such as a public switched telephone network, the Internet and various public and/or private networks.

Satellites that operate in non-geosynchronous orbits, such as low-earth orbit (LEO) satellites, may provide communication coverage to relatively large parts of the earth. In non-geosynchronous satellite-based systems, such as LEO satellite-based systems, the satellites move relative to communication devices (e.g., UEs and gateways) on the ground. When a satellite is within communication range of such communication devices, the satellite may relay communication signals between these devices.

For example, when the satellite 104 is in the relative vicinity of the UE 108, the UE 110, the UE 112, and the gateway 114, the satellite 104 may connect to the gateway 114 via satellite links 116 (e.g., feeder links) and communicate with the UE 108, the UE 110, and the UE 112 via respective satellite links 118, 120, and 122 (e.g., service links). The gateway 114 (e.g., the corresponding ground network) is connected to at least one other network 124 to provide network service to the UEs via the satellites.

The disclosure relates in some aspects to allocating resources in the frequency domain for users of satellites systems or other wireless communication networks. In some examples, this frequency allocation is done in the context of a block-filtered orthogonal frequency division multiplexing (BF-OFDM) scheme. The use of such a scheme enables a desired level of frequency allocation granularity (e.g., a frequency domain resolution of one resource block (RB)) and relatively low cross channel interference.

In some aspects, the disclosure relates to RB-level filtering and the allocation of symbols in the frequency domain, introducing flexibility over the IDFT size (e.g., the inverse fast Fourier transform (IFFT) size). For example, increased flexibility (e.g., relevant for RB-level filtering) may be achieved through the use of an inverse discrete Fourier transform (IDFT) size that is greater than twice a specified physical resource block (PRB) size.

The disclosure relates in some aspects to BF-OFDM employing an IDFT size that is a power-of-two. In some examples, this approach may result in a cyclic prefix length being an integer multiple of samples. Moreover, in some examples, this approach may result in a lower implementation complexity.

The disclosure relates in some aspects to BF-OFDM employing circular shift-based frequency allocation. For example, a transmitter may perform a circular shift, within a frequency allocation, of successive resource block inputs for an IDFT. In some examples, this approach may result in a more efficient use of frequency resources.

Through the use of these techniques, computational complexity may be reduced as compared to prior implementations. In addition, these techniques may provide additional flexibility for compliance with wireless communication standards.

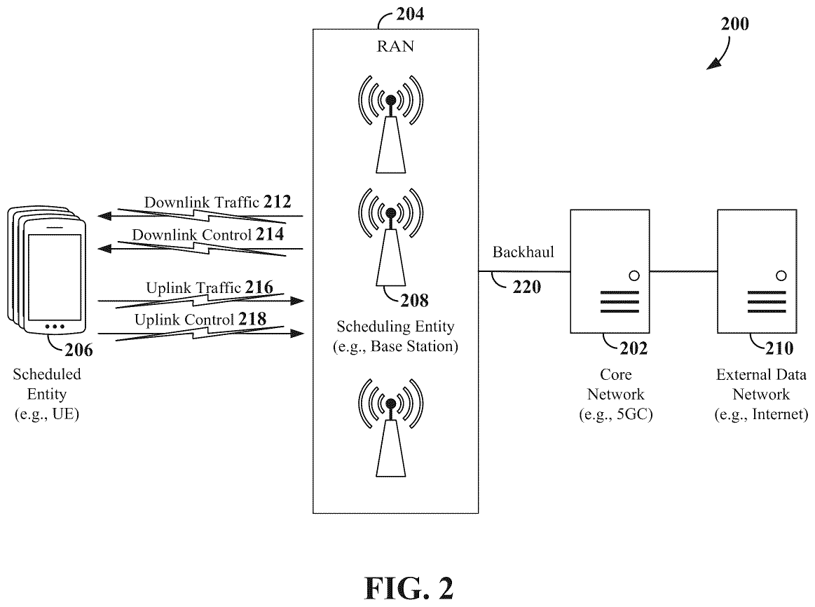

The various concepts presented throughout this disclosure may be implemented across a broad variety of telecommunication systems, network architectures, and communication standards. For example, the teaching herein are applicable to wireless communication systems including non-terrestrial networks (e.g., satellite communication networks) and terrestrial networks (e.g., ground-based 5G networks and the like). Referring to FIG. 2, as an illustrative example without limitation, various aspects of the present disclosure may be illustrated with reference to a wireless communication system 200. The teaching that follow may be applicable to other types of wireless communication systems as well.

The wireless communication system 200 includes three interacting domains: a core network 202, a radio access network (RAN) 204, and a user equipment (UE) 206. By virtue of the wireless communication system 200, the UE 206 may be enabled to carry out data communication with an external data network 210, such as (but not limited to) the Internet.

The RAN 204 may implement any suitable wireless communication technology or technologies to provide radio access to the UE 206. As one example, the RAN 204 may operate according to 3rd Generation Partnership Project (3GPP) New Radio (NR) specifications, often referred to as 5G. As another example, the RAN 204 may operate under a hybrid of 5G NR and Evolved Universal Terrestrial Radio Access Network (eUTRAN) standards, often referred to as Long-Term Evolution (LTE). The 3GPP refers to this hybrid RAN as a next-generation RAN, or NG-RAN. In another example, the RAN 204 may operate according to both the LTE and 5G NR standards. Of course, many other examples may be utilized within the scope of the present disclosure.

As illustrated, the RAN 204 includes a plurality of base stations 208. Broadly, a base station is a network element in a radio access network responsible for radio transmission and reception in one or more cells to or from a UE. In different technologies, standards, or contexts, a base station may variously be referred to by those skilled in the art as a base transceiver station (BTS), a radio base station, a radio transceiver, a transceiver function, a basic service set (BSS), an extended service set (ESS), an access point (AP), a Node B (NB), an eNode B (eNB), a gNode B (gNB), a transmission and reception point (TRP), or some other suitable terminology. In some examples, a base station may include two or more TRPs that may be collocated or non-collocated. Each TRP may communicate on the same or different carrier frequency within the same or different frequency band. In examples where the RAN 204 operates according to both the LTE and 5G NR standards, one of the base stations 208 may be an LTE base station, while another base station may be a 5G NR base station.

The radio access network 204 is further illustrated supporting wireless communication for multiple mobile apparatuses. A mobile apparatus may be referred to as user equipment (UE) 206 in 3GPP standards, but may also be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, or some other suitable terminology. A UE 206 may be an apparatus that provides a user with access to network services. In examples where the RAN 204 operates according to both the LTE and 5G NR standards, the UE 206 may be an Evolved-Universal Terrestrial Radio Access Network-New Radio dual connectivity (EN-DC) UE that is capable of simultaneously connecting to an LTE base station and an NR base station to receive data packets from both the LTE base station and the NR base station.

Within the present document, a mobile apparatus need not necessarily have a capability to move, and may be stationary. The term mobile apparatus or mobile device broadly refers to a diverse array of devices and technologies. UEs may include a number of hardware structural components sized, shaped, and arranged to help in communication; such components can include antennas, antenna arrays, RF chains, amplifiers, one or more processors, etc., electrically coupled to each other. For example, some non-limiting examples of a mobile apparatus include a mobile, a cellular (cell) phone, a smart phone, a session initiation protocol (SIP) phone, a laptop, a personal computer (PC), a notebook, a netbook, a smartbook, a tablet, a personal digital assistant (PDA), and a broad array of embedded systems, e.g., corresponding to an Internet of Things (IoT).

A mobile apparatus may additionally be an automotive or other transportation vehicle, a remote sensor or actuator, a robot or robotics device, a satellite radio, a global positioning system (GPS) device, an object tracking device, a drone, a multi-copter, a quad-copter, a remote control device, a consumer and/or wearable device, such as eyewear, a wearable camera, a virtual reality device, a smart watch, a health or fitness tracker, a digital audio player (e.g., MP3 player), a camera, a game console, etc. A mobile apparatus may additionally be a digital home or smart home device such as a home audio, video, and/or multimedia device, an appliance, a vending machine, intelligent lighting, a home security system, a smart meter, etc. A mobile apparatus may additionally be a smart energy device, a security device, a solar panel or solar array, a municipal infrastructure device controlling electric power (e.g., a smart grid), lighting, water, etc., an industrial automation and enterprise device, a logistics controller, agricultural equipment, etc. Still further, a mobile apparatus may provide for connected medicine or telemedicine support, i.e., health care at a distance. Telehealth devices may include telehealth monitoring devices and telehealth administration devices, whose communication may be given preferential treatment or prioritized access over other types of information, e.g., in terms of prioritized access for transport of critical service data, and/or relevant QoS for transport of critical service data.

Wireless communication between a RAN 204 and a UE 206 may be described as utilizing an air interface. Transmissions over the air interface from a base station (e.g., base station 208) to one or more UEs (e.g., UE 206) may be referred to as downlink (DL) transmission. In some examples, the term downlink may refer to a point-to-multipoint transmission originating at a base station (e.g., base station 208). Another way to describe this point-to-multipoint transmission scheme may be to use the term broadcast channel multiplexing. Transmissions from a UE (e.g., UE 206) to a base station (e.g., base station 208) may be referred to as uplink (UL) transmissions. In some examples, the term uplink may refer to a point-to-point transmission originating at a UE (e.g., UE 206).

In some examples, access to the air interface may be scheduled, wherein a scheduling entity (e.g., a base station 208) of some other type of network entity allocates resources for communication among some or all devices and equipment within its service area or cell. Within the present disclosure, as discussed further below, the scheduling entity may be responsible for scheduling, assigning, reconfiguring, and releasing resources for one or more scheduled entities (e.g., UEs). That is, for scheduled communication, a plurality of UEs 206, which may be scheduled entities, may utilize resources allocated by a scheduling entity (e.g., a base station 208).

Base stations 208 are not the only entities that may function as scheduling entities. That is, in some examples, a UE may function as a scheduling entity, scheduling resources for one or more scheduled entities (e.g., one or more other UEs). For example, UEs may communicate with other UEs in a peer-to-peer or device-to-device fashion and/or in a relay configuration.

As illustrated in FIG. 2, a scheduling entity (e.g., a base station 208) may broadcast downlink traffic 212 to one or more scheduled entities (e.g., a UE 206). Broadly, the scheduling entity is a node or device responsible for scheduling traffic in a wireless communication network, including the downlink traffic 212 and, in some examples, uplink traffic 216 and/or uplink control information 218 from one or more scheduled entities to the scheduling entity. On the other hand, the scheduled entity is a node or device that receives downlink control information 214, including but not limited to scheduling information (e.g., a grant), synchronization or timing information, or other control information from another entity in the wireless communication network such as the scheduling entity.

In addition, the uplink control information 218, downlink control information 214, downlink traffic 212, and/or uplink traffic 216 may be time-divided into frames, subframes, slots, and/or symbols. As used herein, a symbol may refer to a unit of time that, in an orthogonal frequency division multiplexed (OFDM) waveform, carries one resource element (RE) per sub-carrier. A slot may carry 7 or 14 OFDM symbols in some examples. A subframe may refer to a duration of 1 millisecond (ms). Multiple subframes or slots may be grouped together to form a single frame or radio frame. Within the present disclosure, a frame may refer to a predetermined duration (e.g., 10 ms) for wireless transmissions, with each frame consisting of, for example, 10 subframes of 1 ms each. Of course, these definitions are not required, and any suitable scheme for organizing waveforms may be utilized, and various time divisions of the waveform may have any suitable duration.

In general, base stations 208 may include a backhaul interface for communication with a backhaul 220 of the wireless communication system. The backhaul 220 may provide a link between a base station 208 and the core network 202. Further, in some examples, a backhaul network may provide interconnection between the respective base stations 208. Various types of backhaul interfaces may be employed, such as a direct physical connection, a virtual network, or the like using any suitable transport network.

The core network 202 may be a part of the wireless communication system 200, and may be independent of the radio access technology used in the RAN 204. In some examples, the core network 202 may be configured according to 5G standards (e.g., 5GC). In other examples, the core network 202 may be configured according to a 4G evolved packet core (EPC), or any other suitable standard or configuration.

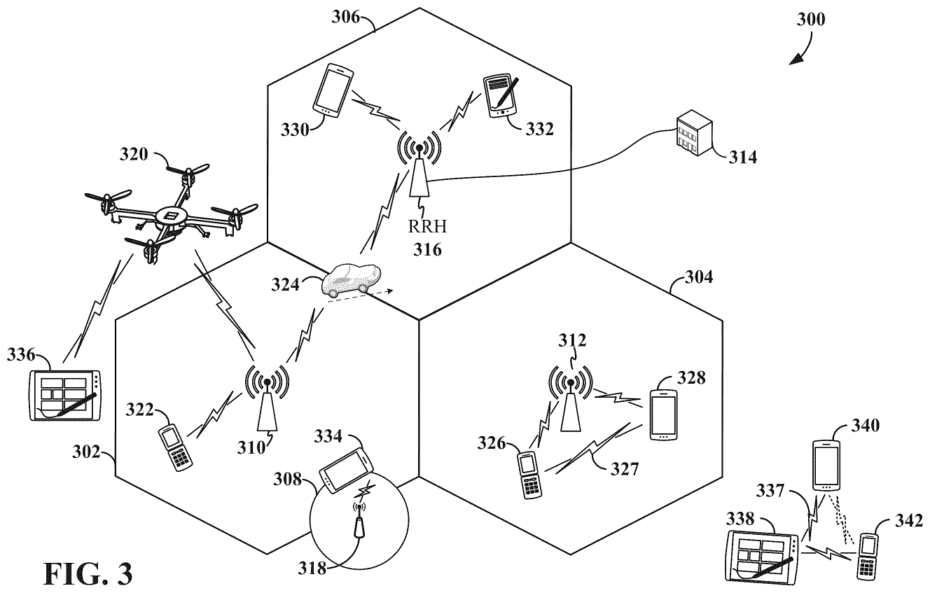

Referring now to FIG. 3, by way of example and without limitation, a schematic illustration of a radio access network (RAN) 300 is provided. In some examples, the RAN 300 may be the same as the RAN 204 described above and illustrated in FIG. 2.

The geographic area covered by the RAN 300 may be divided into cellular regions (cells) that can be uniquely identified by a user equipment (UE) based on an identification broadcasted from one access point or base station. FIG. 3 illustrates cells 302, 304, 306, and 308, each of which may include one or more sectors (not shown). A sector is a sub-area of a cell. All sectors within one cell are served by the same base station. A radio link within a sector can be identified by a single logical identification belonging to that sector. In a cell that is divided into sectors, the multiple sectors within a cell can be formed by groups of antennas with each antenna responsible for communication with UEs in a portion of the cell.

Various base station arrangements can be utilized. For example, in FIG. 3, two base stations 310 and 312 are shown in cells 302 and 304; and a base station 314 is shown controlling a remote radio head (RRH) 316 in cell 306. That is, a base station can have an integrated antenna or can be connected to an antenna or RRH by feeder cables. In the illustrated example, the cells 302, 304, and 306 may be referred to as macrocells, as the base stations 310, 312, and 314 support cells having a large size. Further, a base station 318 is shown in the cell 308, which may overlap with one or more macrocells. In this example, the cell 308 may be referred to as a small cell (e.g., a microcell, picocell, femtocell, home base station, home Node B, home eNode B, etc.), as the base station 318 supports a cell having a relatively small size. Cell sizing can be done according to system design as well as component constraints.

It is to be understood that the RAN 300 may include any number of wireless base stations and cells. Further, a relay node may be deployed to extend the size or coverage area of a given cell. The base stations 310, 312, 314, 318 provide wireless access points to a core network for any number of mobile apparatuses. In some examples, the base stations 310, 312, 314, and/or 318 may be the same as the base station/scheduling entity described above and illustrated in FIG. 2.

FIG. 3 further includes an unmanned aerial vehicle (UAV) 320, which may be a drone or quadcopter. The UAV 320 may be configured to function as a base station, or more specifically as a mobile base station. That is, in some examples, a cell may not necessarily be stationary, and the geographic area of the cell may move according to the location of a mobile base station, such as the UAV 320.

Within the RAN 300, the cells may include UEs that may be in communication with one or more sectors of each cell. Further, each base station 310, 312, 314, and 318 may be configured to provide an access point to a core network 202 (see FIG. 2) for all the UEs in the respective cells. For example, UEs 322 and 324 may be in communication with base station 310; UEs 326 and 328 may be in communication with base station 312; UEs 330 and 332 may be in communication with base station 314 by way of RRH 316; and UE 334 may be in communication with base station 318. In some examples, the UEs 322, 324, 326, 328, 330, 332, 334, 336, 338, 340, and/or 342 may be the same as the UE/scheduled entity described above and illustrated in FIG. 2. In some examples, the UAV 320 (e.g., the quadcopter) can be a mobile network node and may be configured to function as a UE. For example, the UAV 320 may operate within cell 302 by communicating with base station 310.

In a further aspect of the RAN 300, sidelink signals may be used between UEs without necessarily relying on scheduling or control information from a base station. Sidelink communication may be utilized, for example, in a device-to-device (D2D) network, peer-to-peer (P2P) network, vehicle-to-vehicle (V2V) network, vehicle-to-everything (V2X) network, and/or other suitable sidelink network. For example, two or more UEs (e.g., UEs 338, 340, and 342) may communicate with each other using sidelink signals 337 without relaying that communication through a base station. In some examples, the UEs 338, 340, and 342 may each function as a scheduling entity or transmitting sidelink device and/or a scheduled entity or a receiving sidelink device to schedule resources and communicate sidelink signals 337 therebetween without relying on scheduling or control information from a base station. In other examples, two or more UEs (e.g., UEs 326 and 328) within the coverage area of a base station (e.g., base station 312) may also communicate sidelink signals 327 over a direct link (sidelink) without conveying that communication through the base station 312. In this example, the base station 312 may allocate resources to the UEs 326 and 328 for the sidelink communication.

In the RAN 300, the ability for a UE to communicate while moving, independent of its location, is referred to as mobility. The various physical channels between the UE and the radio access network are generally set up, maintained, and released under the control of an access and mobility management function (AMF, not illustrated, part of the core network 202 in FIG. 2), which may include a security context management function (SCMF) that manages the security context for both the control plane and the user plane functionality, and a security anchor function (SEAF) that performs authentication.

A RAN 300 may utilize DL-based mobility or UL-based mobility to enable mobility and handovers (i.e., the transfer of a UE's connection from one radio channel to another). In a network configured for DL-based mobility, during a call with a scheduling entity, or at any other time, a UE may monitor various parameters of the signal from its serving cell as well as various parameters of neighboring cells. Depending on the quality of these parameters, the UE may maintain communication with one or more of the neighboring cells. During this time, if the UE moves from one cell to another, or if signal quality from a neighboring cell exceeds that from the serving cell for a given amount of time, the UE may undertake a handoff or handover from the serving cell to the neighboring (target) cell. For example, UE 324 (illustrated as a vehicle, although any suitable form of UE may be used) may move from the geographic area corresponding to its serving cell (e.g., the cell 302) to the geographic area corresponding to a neighbor cell (e.g., the cell 306). When the signal strength or quality from the neighbor cell exceeds that of the serving cell for a given amount of time, the UE 324 may transmit a reporting message to its serving base station (e.g., the base station 310) indicating this condition. In response, the UE 324 may receive a handover command, and the UE may undergo a handover to the cell 306.

In a network configured for UL-based mobility, UL reference signals from each UE may be utilized by the network to select a serving cell for each UE. In some examples, the base stations 310, 312, and 314/316 may broadcast unified synchronization signals (e.g., unified Primary Synchronization Signals (PSSs), unified Secondary Synchronization Signals (SSSs) and unified Physical Broadcast Channels (PBCH)). The UEs 322, 324, 326, 328, 330, and 332 may receive the unified synchronization signals, derive the carrier frequency and slot timing from the synchronization signals, and in response to deriving timing, transmit an uplink pilot or reference signal. The uplink pilot signal transmitted by a UE (e.g., UE 324) may be concurrently received by two or more cells (e.g., base stations 310 and 314/316) within the RAN 300. Each of the cells may measure a strength of the pilot signal, and the radio access network (e.g., one or more of the base stations 310 and 314/316 and/or a central node within the core network) may determine a serving cell for the UE 324. As the UE 324 moves through the RAN 300, the network may continue to monitor the uplink pilot signal transmitted by the UE 324. When the signal strength or quality of the pilot signal measured by a neighboring cell exceeds that of the signal strength or quality measured by the serving cell, the RAN 300 may handover the UE 324 from the serving cell to the neighboring cell, with or without informing the UE 324.

Although the synchronization signal transmitted by the base stations 310, 312, and 314/316 may be unified, the synchronization signal may not identify a particular cell, but rather may identify a zone of multiple cells operating on the same frequency and/or with the same timing. The use of zones in 5G networks or other next generation communication networks enables the uplink-based mobility framework and improves the efficiency of both the UE and the network, since the number of mobility messages that need to be exchanged between the UE and the network may be reduced.

In various implementations, the air interface in the RAN 300 may utilize licensed spectrum, unlicensed spectrum, or shared spectrum. Licensed spectrum provides for exclusive use of a portion of the spectrum, generally by virtue of a mobile network operator purchasing a license from a government regulatory body. Unlicensed spectrum provides for shared use of a portion of the spectrum without the need for a government-granted license. While compliance with some technical rules is generally still required to access unlicensed spectrum, generally, any operator or device may gain access. Shared spectrum may fall between licensed and unlicensed spectrum, wherein technical rules or limitations may be required to access the spectrum, but the spectrum may still be shared by multiple operators and/or multiple radio access technologies (RATs). For example, the holder of a license for a portion of licensed spectrum may provide licensed shared access (LSA) to share that spectrum with other parties, e.g., with suitable licensee-determined conditions to gain access.

The air interface in the RAN 300 may utilize one or more multiplexing and multiple access algorithms to enable simultaneous communication of the various devices. For example, 5G NR specifications provide multiple access for UL transmissions from UEs 322 and 324 to base station 310, and for multiplexing for DL transmissions from base station 310 to one or more UEs 322 and 324, utilizing orthogonal frequency division multiplexing (OFDM) with a cyclic prefix (CP). In addition, for UL transmissions, 5G NR specifications provide support for discrete Fourier transform-spread-OFDM (DFT-s-OFDM) with a CP (also referred to as single-carrier FDMA (SC-FDMA)). However, within the scope of the present disclosure, multiplexing and multiple access are not limited to the above schemes, and may be provided utilizing time division multiple access (TDMA), code division multiple access (CDMA), frequency division multiple access (FDMA), sparse code multiple access (SCMA), resource spread multiple access (RSMA), or other suitable multiple access schemes. Further, multiplexing DL transmissions from the base station 310 to UEs 322 and 324 may be provided utilizing time division multiplexing (TDM), code division multiplexing (CDM), frequency division multiplexing (FDM), orthogonal frequency division multiplexing (OFDM), sparse code multiplexing (SCM), or other suitable multiplexing schemes.

The air interface in the RAN 300 may further utilize one or more duplexing algorithms. Duplex refers to a point-to-point communication link where both endpoints can communicate with one another in both directions. Full-duplex means both endpoints can simultaneously communicate with one another. Half-duplex means only one endpoint can send information to the other at a time. Half-duplex emulation is frequently implemented for wireless links utilizing time division duplex (TDD). In TDD, transmissions in different directions on a given channel are separated from one another using time division multiplexing. That is, at some times the channel is dedicated for transmissions in one direction, while at other times the channel is dedicated for transmissions in the other direction, where the direction may change very rapidly, e.g., several times per slot. In a wireless link, a full-duplex channel generally relies on physical isolation of a transmitter and receiver, and suitable interference cancelation technologies. Full-duplex emulation is frequently implemented for wireless links by utilizing frequency division duplex (FDD) or spatial division duplex (SDD). In FDD, transmissions in different directions operate at different carrier frequencies. In SDD, transmissions in different directions on a given channel are separate from one another using spatial division multiplexing (SDM). In other examples, full-duplex communication may be implemented within unpaired spectrum (e.g., within a single carrier bandwidth), where transmissions in different directions occur within different sub-bands of the carrier bandwidth. This type of full-duplex communication may be referred to as sub-band full-duplex (SBFD), cross-division duplex (xDD), or flexible duplex.

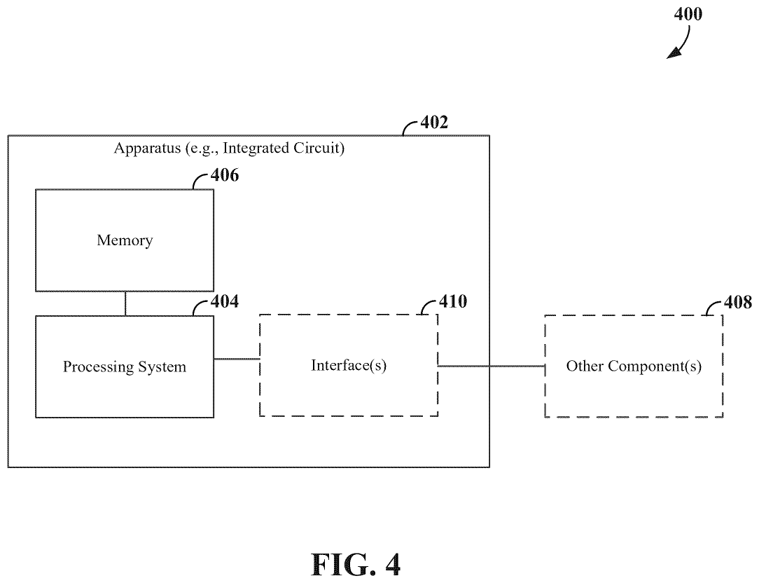

FIG. 4 illustrates an example apparatus 400 according to certain aspects of the disclosure. In some examples, the apparatus 400 may be a network entity (e.g., a BS), a UE, or some other type of wireless node (e.g., a node that utilizes wireless spectrum (e.g., a particular RF spectrum) to communicate with another node or entity). In some examples, the apparatus 400 may correspond to any of the apparatuses, UEs, scheduled entities, network entities, base stations (e.g., gNBs), scheduling entities, DUs, CUs, RAN nodes, gateways, network nodes, or CN entities shown in any of FIGS. 1, 2, 3, 5, 8, 9, 14, 15, and 17.

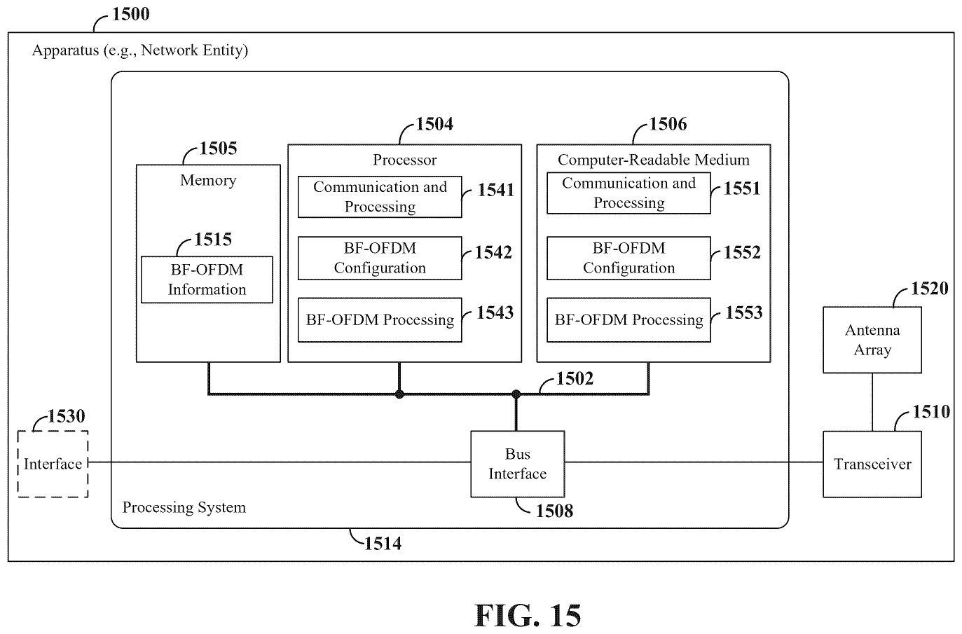

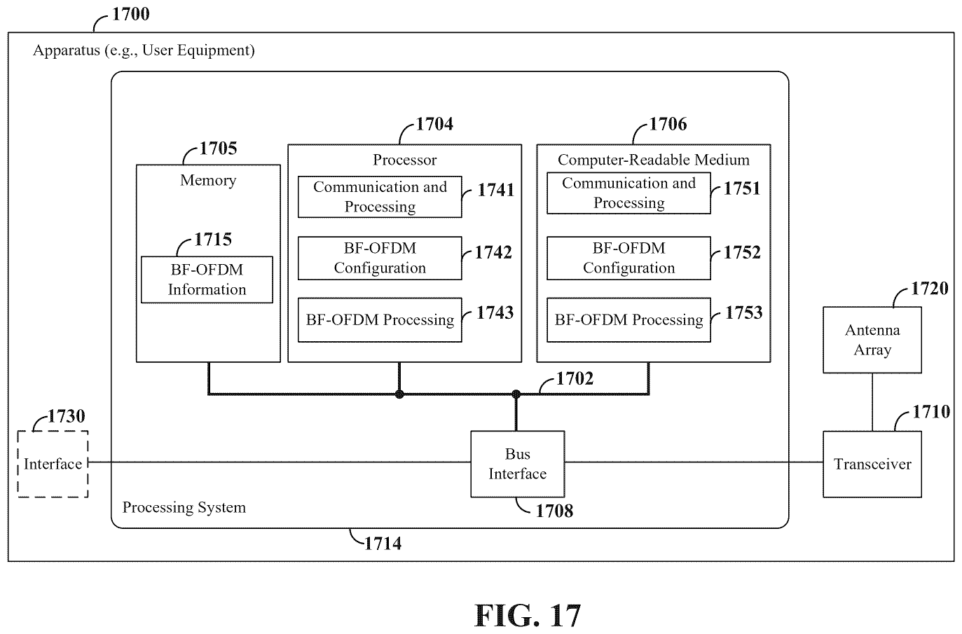

The apparatus 400 includes an apparatus 402 (e.g., an integrated circuit) and, optionally, at least one other component 408. In some aspects, the apparatus 402 may be configured to operate in a wireless communication device (e.g., a UE, a BS, etc.) and to perform one or more of the operations described herein. The apparatus 402 includes a processing system 404 (e.g., including one or more processors), and a memory 406 (e.g., representative of one or more memories) coupled to the processing system 404. Example implementations of the processing system 404 are provided herein. In some examples, the processing system 404 of FIG. 4 may correspond to the processing system 1514 of FIG. 15. In some examples, the processing system 404 of FIG. 4 may correspond to the processing system 1714 of FIG. 17.

The processing system 404 is generally adapted for processing, including the execution of programming (e.g., processor-executable code) stored on the memory 406. For example, the memory 406 may store instructions that, when executed by the processing system 404, cause the processing system 404 to perform one or more of the operations described herein.

In some implementations, the apparatus 402 communicates with at least one other component (e.g., a component 408 external to the apparatus 402) of the apparatus 400. To this end, in some implementations, the apparatus 402 may include at least one interface 410 (e.g., a send and/or receive interface) coupled to the processing system 404 for outputting and/or obtaining (e.g., sending and/or receiving) information (e.g., received information, generated information, decoded information, messages, etc.) between the processing system 404 and the other component(s) 408. In some implementations, the interface 410 may include an interface bus, bus drivers, bus receivers, buffers, other suitable circuitry, or a combination thereof. In some implementations, the interface 410 may include radio frequency (RF) circuitry (e.g., an RF transmitter and/or an RF receiver). In some implementations, the interface 410 may be configured to interface the apparatus 402 to one or more other components of the apparatus 400 (other components not shown in FIG. 4). For example, the interface 410 may be configured to interface the processing system 404 to a radio frequency (RF) front end (e.g., an RF transmitter and/or an RF receiver).

The apparatus 402 may communicate with other apparatuses in various ways. In cases where the apparatus 402 includes an RF transceiver (not shown in FIG. 4), the apparatus may transmit and receive information (e.g., a frame, a message, bits, etc.) via RF signaling. In some cases, rather than transmitting information via RF signaling, the apparatus 402 may have an interface to provide (e.g., output, send, transmit, etc.) information for RF transmission. For example, the processing system 404 may output information, via a bus interface, to an RF front end for RF transmission. Similarly, rather than receiving information via RF signaling, the apparatus 402 may have an interface to obtain information that is received by another apparatus. For example, the processing system 404 may obtain (e.g., receive) information, via a bus interface, from an RF receiver that received the information via RF signaling. In some implementations, an interface may include multiple interfaces. For example, a bidirectional interface may include a first interface for obtaining and a second interface for outputting.

Deployment of communication systems, such as 5G new radio (NR) systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmit receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CUs, the DUs, and the RUs can also be implemented as virtual units, i.e., a virtual central unit (VCU), a virtual distributed unit (VDU), or a virtual radio unit (VRU).

Base station-type operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

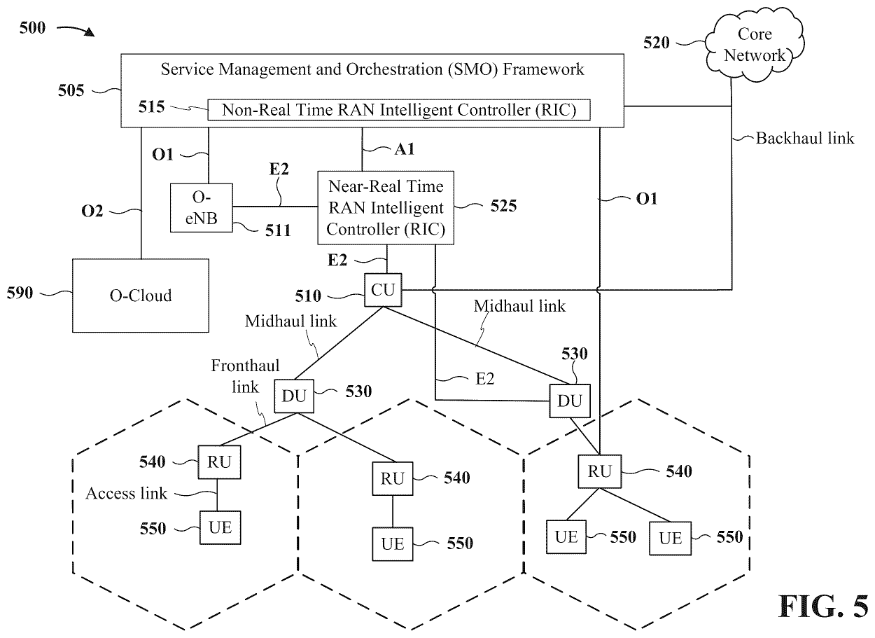

FIG. 5 shows a diagram illustrating an example disaggregated base station 500 architecture. The disaggregated base station 500 architecture may include one or more central units (CUs) 510 that can communicate directly with a core network 520 via a backhaul link, or indirectly with the core network 520 through one or more disaggregated base station units (such as a Near-Real Time (Near-RT) RAN Intelligent Controller (RIC) 525 via an E2 link, or a Non-Real Time (Non-RT) RIC 515 associated with a Service Management and Orchestration (SMO) Framework 505, or both). A CU 510 may communicate with one or more distributed units (DUs) 530 via respective midhaul links, such as an F1 interface. The DUs 530 may communicate with one or more radio units (RUs) 540 via respective fronthaul links. The RUs 540 may communicate with respective UEs 550 via one or more radio frequency (RF) access links. In some implementations, the UE 550 may be simultaneously served by multiple RUs 540.

Each of the units, i.e., the CUs 510, the DUs 530, the RUs 540, as well as the Near-RT RICs 525, the Non-RT RICs 515 and the SMO Framework 505, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 510 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 510. The CU 510 may be configured to handle user plane functionality (i.e., Central Unit-User Plane (CU-UP)), control plane functionality (i.e., Central Unit-Control Plane (CU-CP)), or a combination thereof. In some implementations, the CU 510 can be logically split into one or more CU-UP units and one or more CU-CP units. The CU-UP unit can communicate bidirectionally with the CU-CP unit via an interface, such as the E1 interface when implemented in an O-RAN configuration. The CU 510 can be implemented to communicate with the distributed unit (DU) 530, as necessary, for network control and signaling.

The DU 530 may correspond to a logical unit that includes one or more base station functions to control the operation of one or more RUs 540. In some aspects, the DU 530 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3^{rd} Generation Partnership Project (3GPP). In some aspects, the DU 530 may further host one or more low PHY layers. Each layer (or module) can be implemented with an interface configured to communicate signals with other layers (and modules) hosted by the DU 530, or with the control functions hosted by the CU 510.

Lower-layer functionality can be implemented by one or more RUs 540. In some deployments, an RU 540, controlled by a DU 530, may correspond to a logical node that hosts RF processing functions, or low-PHY layer functions (such as performing discrete Fourier transform (DFT), IDFT, fast Fourier transform (FFT), inverse FFT (IFFT), digital beamforming, physical random access channel (PRACH) extraction and filtering, or the like), or both, based at least in part on the functional split, such as a lower layer functional split. In such an architecture, the RU(s) 540 can be implemented to handle over the air (OTA) communication with one or more UEs 550. In some implementations, real-time and non-real-time aspects of control and user plane communication with the RU(s) 540 can be controlled by the corresponding DU 530. In some scenarios, this configuration can enable the DU(s) 530 and the CU 510 to be implemented in a cloud-based RAN architecture, such as a vRAN architecture.

The SMO Framework 505 may be configured to support RAN deployment and provisioning of non-virtualized and virtualized network elements. For non-virtualized network elements, the SMO Framework 505 may be configured to support the deployment of dedicated physical resources for RAN coverage requirements which may be managed via an operations and maintenance interface (such as an O1 interface). For virtualized network elements, the SMO Framework 505 may be configured to interact with a cloud computing platform (such as an open cloud (O-Cloud) 590) to perform network element life cycle management (such as to instantiate virtualized network elements) via a cloud computing platform interface (such as an O2 interface). Such virtualized network elements can include, but are not limited to, CUs 510, DUs 530, RUs 540 and Near-RT RICs 525. In some implementations, the SMO Framework 505 can communicate with a hardware aspect of a 4G RAN, such as an open eNB (O-eNB) 511, via an O1 interface. Additionally, in some implementations, the SMO Framework 505 can communicate directly with one or more RUs 540 via an O1 interface. The SMO Framework 505 also may include a Non-RT RIC 515 configured to support functionality of the SMO Framework 505.

The Non-RT RIC 515 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 525. The Non-RT RIC 515 may be coupled to or communicate with (such as via an A1 interface) the Near-RT RIC 525. The Near-RT RIC 525 may be configured to include a logical function that enables near-real-time control and optimization of RAN elements and resources via data collection and actions over an interface (such as via an E2 interface) connecting one or more CUs 510, one or more DUs 530, or both, as well as an O-eNB, with the Near-RT RIC 525.

In some implementations, to generate AI/ML models to be deployed in the Near-RT RIC 525, the Non-RT RIC 515 may receive parameters or external enrichment information from external servers. Such information may be utilized by the Near-RT RIC 525 and may be received at the SMO Framework 505 or the Non-RT RIC 515 from non-network data sources or from network functions. In some examples, the Non-RT RIC 515 or the Near-RT RIC 525 may be configured to tune RAN behavior or performance. For example, the Non-RT RIC 515 may monitor long-term trends and patterns for performance and employ AI/ML models to perform corrective actions through the SMO Framework 505 (such as reconfiguration via O1) or via creation of RAN management policies (such as A1 policies).

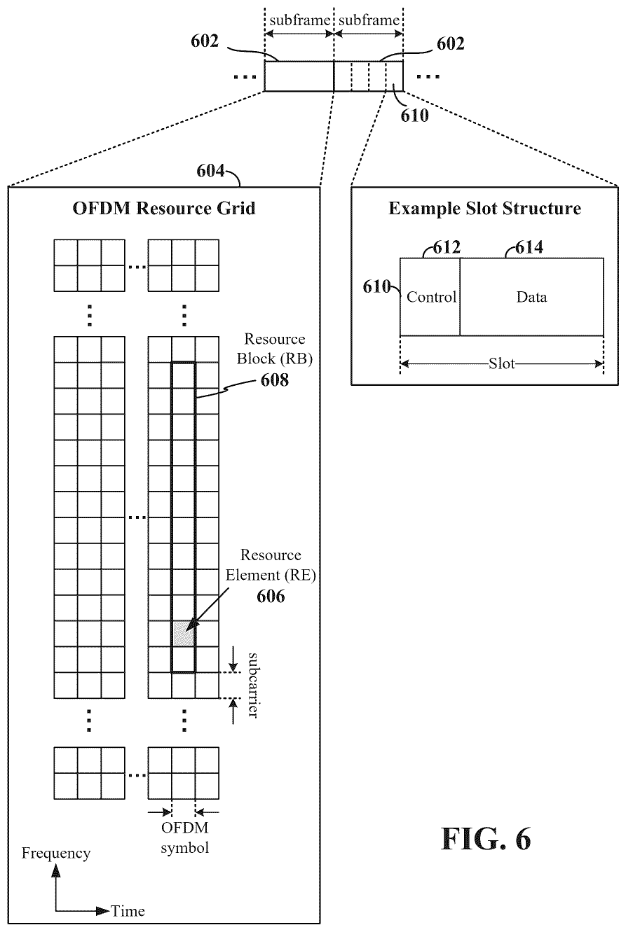

Various aspects of the present disclosure will be described with reference to an OFDM waveform, an example of which is schematically illustrated in FIG. 6. It should be understood by those of ordinary skill in the art that the various aspects of the present disclosure may be applied to an SC-FDMA waveform in substantially the same way as described herein below. That is, while some examples of the present disclosure may focus on an OFDM link for clarity, it should be understood that the same principles may be applied as well to SC-FDMA waveforms.

Referring now to FIG. 6, an expanded view of an example subframe 602 is illustrated, showing an OFDM resource grid. However, as those skilled in the art will readily appreciate, the physical (PHY) layer transmission structure for any particular application may vary from the example described here, depending on any number of factors. Here, time is in the horizontal direction with units of OFDM symbols; and frequency is in the vertical direction with units of subcarriers of the carrier.

The resource grid 604 may be used to schematically represent time-frequency resources for a given antenna port. In some examples, an antenna port is a logical entity used to map data streams to one or more antennas. Each antenna port may be associated with a reference signal (e.g., which may allow a receiver to distinguish data streams associated with the different antenna ports in a received transmission). An antenna port may be defined such that the channel over which a symbol on the antenna port is conveyed can be inferred from the channel over which another symbol on the same antenna port is conveyed. Thus, a given antenna port may represent a specific channel model associated with a particular reference signal. In some examples, a given antenna port and sub-carrier spacing (SCS) may be associated with a corresponding resource grid (including REs as discussed above). Here, modulated data symbols from multiple-input-multiple-output (MIMO) layers may be combined and re-distributed to each of the antenna ports, then precoding is applied, and the precoded data symbols are applied to corresponding REs for OFDM signal generation and transmission via one or more physical antenna elements. In some examples, the mapping of an antenna port to a physical antenna may be based on beamforming (e.g., a signal may be transmitted on certain antenna ports to form a desired beam). Thus, a given antenna port may correspond to a particular set of beamforming parameters (e.g., signal phases and/or amplitudes).

In a MIMO implementation with multiple antenna ports available, a corresponding multiple number of resource grids 604 may be available for communication. The resource grid 604 is divided into multiple resource elements (REs) 606. An RE, which is 1 subcarrier×1 symbol, is the smallest discrete part of the time—frequency grid, and contains a single complex value representing data from a physical channel or signal. Depending on the modulation utilized in a particular implementation, each RE may represent one or more bits of information. In some examples, a block of REs may be referred to as a physical resource block (PRB) or more simply a resource block (RB) 608, which contains any suitable number of consecutive subcarriers in the frequency domain. In one example, an RB may include 12 subcarriers, a number independent of the numerology used. In some examples, depending on the numerology, an RB may include any suitable number of consecutive OFDM symbols in the time domain. Within the present disclosure, it is assumed that a single RB such as the RB 608 entirely corresponds to a single direction of communication (either transmission or reception for a given device).

A set of continuous or discontinuous resource blocks may be referred to herein as a Resource Block Group (RBG), sub-band, or bandwidth part (BWP). A set of sub-bands or BWPs may span the entire bandwidth. Scheduling of scheduled entities (e.g., UEs) for downlink, uplink, or sidelink transmissions typically involves scheduling one or more resource elements 606 within one or more sub-bands or bandwidth parts (BWPs). Thus, a UE generally utilizes only a subset of the resource grid 604. In some examples, an RB may be the smallest unit of resources that can be allocated to a UE. Thus, the more RBs scheduled for a UE, and the higher the modulation scheme chosen for the air interface, the higher the data rate for the UE. The RBs may be scheduled by a scheduling entity, such as a base station (e.g., gNB, eNB, etc.), or may be self-scheduled by a UE implementing D2D sidelink communication.

In this illustration, the RB 608 is shown as occupying less than the entire bandwidth of the subframe 602, with some subcarriers illustrated above and below the RB 608. In a given implementation, the subframe 602 may have a bandwidth corresponding to any number of one or more RBs 608. Further, in this illustration, the RB 608 is shown as occupying less than the entire duration of the subframe 602, although this is merely one possible example.

Each 1 ms subframe 602 may consist of one or multiple adjacent slots. In the example shown in FIG. 6, one subframe 602 includes four slots 610, as an illustrative example. In some examples, a slot may be defined according to a specified number of OFDM symbols with a given cyclic prefix (CP) length. For example, a slot may include 7 or 14 OFDM symbols with a nominal CP. Additional examples may include mini-slots, sometimes referred to as shortened transmission time intervals (TTIs), having a shorter duration (e.g., one to three OFDM symbols). These mini-slots or shortened transmission time intervals (TTIs) may in some cases be transmitted occupying resources scheduled for ongoing slot transmissions for the same or for different UEs. Any number of resource blocks may be utilized within a subframe or slot.

An expanded view of one of the slots 610 illustrates the slot 610 including a control region 612 and a data region 614. In general, the control region 612 may carry control channels, and the data region 614 may carry data channels. Of course, a slot may contain all DL, all UL, or at least one DL portion and at least one UL portion. The structure illustrated in FIG. 6 is merely an example, and different slot structures may be utilized, and may include one or more of each of the control region(s) and data region(s).

Although not illustrated in FIG. 6, the various REs 606 within an RB 608 may be scheduled to carry one or more physical channels, including control channels, shared channels, data channels, etc. Other REs 606 within the RB 608 may also carry pilots or reference signals. These pilots or reference signals may provide for a receiving device to perform channel estimation of the corresponding channel, which may enable coherent demodulation/detection of the control and/or data channels within the RB 608.

In some examples, the slot 610 may be utilized for broadcast, multicast, groupcast, or unicast communication. For example, a broadcast, multicast, or groupcast communication may refer to a point-to-multipoint transmission by one device (e.g., a base station, UE, or other similar device) to other devices. Here, a broadcast communication is delivered to all devices, whereas a multicast or groupcast communication is delivered to multiple intended recipient devices. A unicast communication may refer to a point-to-point transmission by a one device to a single other device.

In an example of cellular communication over a cellular carrier via a Uu interface, for a DL transmission, the scheduling entity (e.g., a base station) may allocate one or more REs 606 (e.g., within the control region 612) to carry DL control information including one or more DL control channels, such as a physical downlink control channel (PDCCH), to one or more scheduled entities (e.g., UEs). The PDCCH carries downlink control information (DCI) including but not limited to power control commands (e.g., one or more open loop power control parameters and/or one or more closed loop power control parameters), scheduling information, a grant, and/or an assignment of REs for DL and UL transmissions. The PDCCH may further carry hybrid automatic repeat request (HARQ) feedback transmissions such as an acknowledgment (ACK) or negative acknowledgment (NACK). HARQ is a technique well-known to those of ordinary skill in the art, wherein the integrity of packet transmissions may be checked at the receiving side for accuracy, e.g., utilizing any suitable integrity checking mechanism, such as a checksum or a cyclic redundancy check (CRC). If the integrity of the transmission is confirmed, an ACK may be transmitted, whereas if not confirmed, a NACK may be transmitted. In response to a NACK, the transmitting device may send a HARQ retransmission, which may implement chase combining, incremental redundancy, etc.

The base station may further allocate one or more REs 606 (e.g., in the control region 612 or the data region 614) to carry other DL signals, such as a demodulation reference signal (DMRS); a phase-tracking reference signal (PT-RS); a channel state information (CSI) reference signal (CSI-RS); and a synchronization signal block (SSB). SSBs may be broadcast at regular intervals based on a periodicity (e.g., 5, 10, 20, 30, 80, or 130 ms). An SSB includes a primary synchronization signal (PSS), a secondary synchronization signal (SSS), and a physical broadcast control channel (PBCH). A UE may utilize the PSS and SSS to achieve radio frame, subframe, slot, and symbol synchronization in the time domain, identify the center of the channel (system) bandwidth in the frequency domain, and identify the physical cell identity (PCI) of the cell.

The PBCH in the SSB may further include a master information block (MIB) that includes various system information, along with parameters for decoding a system information block (SIB). The SIB may be, for example, a SystemInformationType 1 (SIB1) that may include various additional (remaining) system information. The MIB and SIB1 together provide the minimum system information (SI) for initial access. Examples of system information transmitted in the MIB may include, but are not limited to, a subcarrier spacing (e.g., default downlink numerology), system frame number, a configuration of a PDCCH control resource set (CORESET) (e.g., PDCCH CORESET0), a cell barred indicator, a cell reselection indicator, a raster offset, and a search space for SIB1. Examples of remaining minimum system information (RMSI) transmitted in the SIB1 may include, but are not limited to, a random access search space, a paging search space, downlink configuration information, and uplink configuration information. A base station may transmit other system information (OSI) as well.

In an UL transmission, the UE may utilize one or more REs 606 to carry UL control information (UCI) including one or more UL control channels, such as a physical uplink control channel (PUCCH), to the scheduling entity. UCI may include a variety of packet types and categories, including pilots, reference signals, and information configured to enable or assist in decoding uplink data transmissions. Examples of uplink reference signals may include a sounding reference signal (SRS) and an uplink DMRS. In some examples, the UCI may include a scheduling request (SR), i.e., request for the scheduling entity to schedule uplink transmissions. Here, in response to the SR transmitted on the UCI, the scheduling entity may transmit downlink control information (DCI) that may schedule resources for uplink packet transmissions. UCI may also include HARQ feedback, channel state feedback (CSF), such as a CSI report, or any other suitable UCI.

In addition to control information, one or more REs 606 (e.g., within the data region 614) may be allocated for data traffic. Such data traffic may be carried on one or more traffic channels, such as, for a DL transmission, a physical downlink shared channel (PDSCH); or for an UL transmission, a physical uplink shared channel (PUSCH). In some examples, one or more REs 606 within the data region 614 may be configured to carry other signals, such as one or more SIBs and DMRSs.

In an example of sidelink communication over a sidelink carrier via a proximity service (ProSe) PC5 interface, the control region 612 of the slot 610 may include a physical sidelink control channel (PSCCH) including sidelink control information (SCI) transmitted by an initiating (transmitting) sidelink device (e.g., a transmitting (Tx) V2X device or other Tx UE) towards a set of one or more other receiving sidelink devices (e.g., a receiving (Rx) V2X device or some other Rx UE). The data region 614 of the slot 610 may include a physical sidelink shared channel (PSSCH) including sidelink data traffic transmitted by the initiating (transmitting) sidelink device within resources reserved over the sidelink carrier by the transmitting sidelink device via the SCI. Other information may further be transmitted over various REs 606 within slot 610. For example, HARQ feedback information may be transmitted in a physical sidelink feedback channel (PSFCH) within the slot 610 from the receiving sidelink device to the transmitting sidelink device. In addition, one or more reference signals, such as a sidelink SSB, a sidelink CSI-RS, a sidelink SRS, and/or a sidelink positioning reference signal (PRS) may be transmitted within the slot 610.

These physical channels described above are generally multiplexed and mapped to transport channels for handling at the medium access control (MAC) layer. Transport channels carry blocks of information called transport blocks (TB). The transport block size (TBS), which may correspond to a number of bits of information, may be a controlled parameter, based on the modulation and coding scheme (MCS) and the number of RBs in a given transmission.

The channels or carriers described above with reference to FIGS. 1-6 are not necessarily all of the channels or carriers that may be utilized between a scheduling entity and scheduled entities, and those of ordinary skill in the art will recognize that other channels or carriers may be utilized in addition to those illustrated, such as other traffic, control, and feedback channels.

As mentioned above, a wireless communication network may utilize one or more multiplexing and multiple access schemes, such as OFDM with CP, to enable simultaneous communication by multiple devices in the network. Different wireless communication networks may have different requirements that impact how the multiplexing and multiple access is implemented.

For example, a non-terrestrial network (NTN) entity such as a LEO satellite may simultaneously communicate with multiple UEs. Consequently, multiplexing and multiple access may be applied for UE downlink access (and/or UE uplink access) in a non-terrestrial (NT) scenario.

In some examples, a desired communication performance characteristic of an NTN may involve providing a sufficient frequency domain resolution for downlink and/or uplink access. For example, the ability to flexibly allocate users in the frequency domain with a resolution of one resource block (RB) (e.g., the minimum granularity considered in 5G NR) may be a desired goal in some cases.

In some examples, an NTN (or other wireless communication network) may use a block-filtered orthogonal frequency division multiplexing (BF-OFDM) waveform in the downlink and/or in the uplink to achieve performance goals. In some aspects, the use of BF-OFDM enables filtering of a signal at an RB-level (e.g., for every RB in frequency, a filter may be applied). In other words, BF-OFDM may be characterized in some examples as OFDM where it is possible to filter each RB independently and then add them together. In a BF-OFDM implementation, any negative impact on adjacent channels in the physical surroundings due to out-of-band radiation may be mitigated through the use of RB-level filtering. The use of BF-OFDM may also enable relatively high spectrum reuse, while avoiding interfering with other services in the deployment area. In general, a high level of frequency containment is desirable for an increased tolerance to synchronization errors (e.g., as in global navigation satellite system (GNSS) free operation), especially in the case of a non-contiguous frequency allocation.

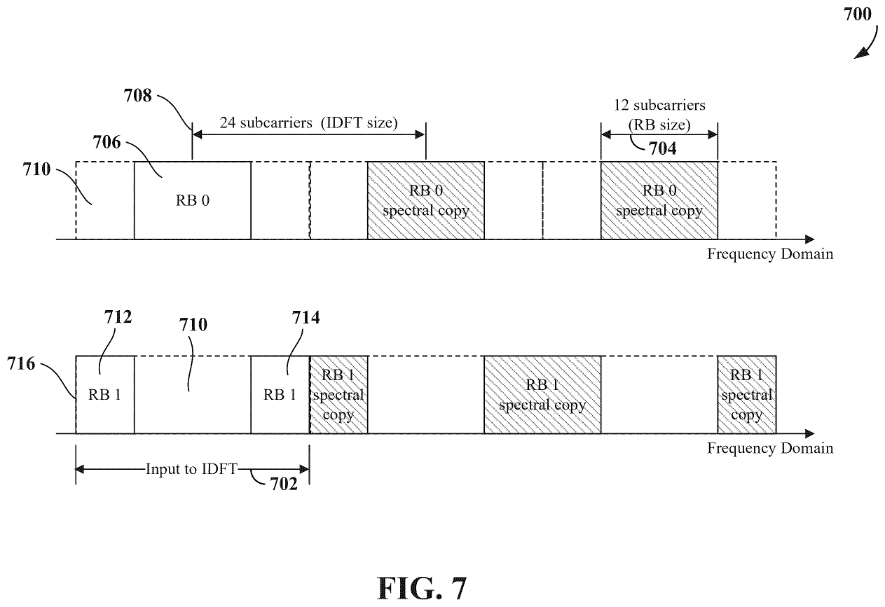

FIG. 7 illustrates a conceptual example of a BF-OFDM waveform 700 in the frequency domain. Here, frequency increases along the x-axis. In this example, the size of the allocated spectrum is 24 subcarriers, corresponding to the size of the input 702 to an IDFT module for the BF-OFDM waveform generation. Also, the RB size 704 is 12 subcarriers in this case.

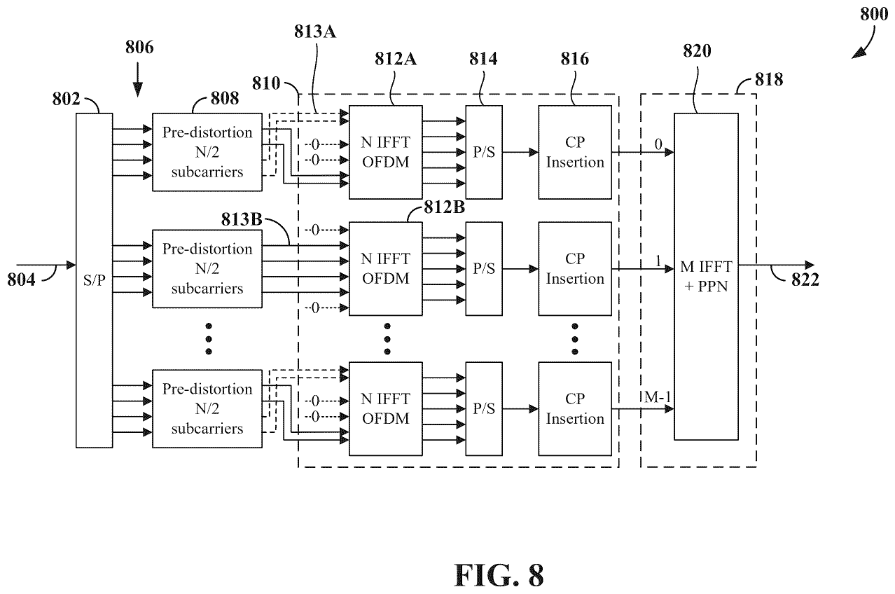

BF-OFDM symbols are allocated to the frequency domain according to the parity of the corresponding RB indices for the symbols. For example, the symbols associated with even RB indices (e.g., RB 0, RB 2, etc.) are placed at the center of the allocated spectrum, while the symbols associated with odd RB indices (e.g., RB 1, RB 3, etc.) are placed at the extremes of the allocated spectrum. The same holds true for each spectral copy of each RB (e.g., which represent up-sampling of the signals due to the use of some zeroed IFFT inputs as discussed below in conjunction with FIG. 8).

Thus, as shown in FIG. 7, RB 0 706 is placed at the center 708 of a frequency allocation 710. In addition, RB 1 is split in half (upper 6 subcarriers 712 and lower 6 subcarriers 714), where each half is placed by an edge (e.g., edge 716) of the frequency allocation 710. From FIG. 7 it may also be seen that this approach involves a fixed allocation of 50% of the IDFT input 702.

FIG. 8 illustrates an example of a transmitter 800 that generates a BF-OFDM waveform. A serial-to-parallel (S/P) converter 802 converts a serial frequency domain input signal 804 to parallel to provide M sets of N/2 frequency signals 806 to M per-RB prototype filter pre-distortion modules (e.g., including a pre-distortion N/2 subcarriers module 808). M sets of predistortion signals are thus provided to an OFDM precoding block 810 using a parity based allocation scheme as discussed above. To reduce the complexity of FIG. 8, only four signals are shown as inputs and outputs for each pre-distortion module. More generally, each of the M blocks in the pre-distortion stage has N/2 inputs and outputs.

The OFDM precoding block 810 includes M sets of N IFFT OFDM modules (e.g., including an IFFT OFDM module 812A and an IFFT OFDM module 812B), M parallel-to-serial (P/S) converters (e.g., including a P/S converter 814), and M CP insertion modules (e.g., including a CP insertion module 816).

In some examples, an IFFT module computes the IDFT of a sequence. For example, each IFFT OFDM module converts frequency domain input signals to time domain signals. The IFFT modules may be overlapped to some extent, whereby the inputs of the IFFT modules are configured so that they do not interfere with each other at the correct RB location for every branch out of the M displayed in FIG. 8. For example, some inputs (e.g., half of the inputs) are left empty to provide room for filter roll off. The passband of the filter (e.g., a filter bank stage 818) passes the subcarriers substantially distortion free while rejecting signals outside of the passband. By leaving some of the inputs empty, this prevents data from being sent in the roll off regions of the filter (which could result in unwanted interference). In the example of FIG. 8, the input to each IFFT OFDM module involves an alternating allocation of symbols in the frequency domain based on the RB index parity. For example, for the instance of the IFFT OFDM module 812A shown in FIG. 8, symbols (e.g., signal 813A) will be at the extremes of the allocated spectrum while zeros (0s) will be at the center of the spectrum. Conversely, for the instance of the IFFT OFDM module 812B shown in FIG. 8, symbols (e.g., signal 813B) will be at the center of the allocated spectrum while zeros (0s) will be at the extremes of the spectrum.

Each IFFT OFDM module outputs the resulting time domain signals to a corresponding P/S converter. Each P/S converter converts these parallel time domain signals to serial time domain signals (e.g., each consisting of a sequence with a size of 24 symbols) that are output to respective CP insertion modules. Each CP insertion module feeds a resulting serial time domain signal with a CP inserted (e.g., having a collective size that is slightly greater than 24 symbols) to the filter bank stage 818.

In the example of FIG. 8, the filter bank stage 818 includes M polyphase network (PPN) filters 820 (e.g., to improve localization in time and frequency). In some examples, the filter bank stage 818 centers each filter from the bank (e.g., corresponding to a particular RB) in the correct location in the frequency domain (e.g., corresponding to locations of the RBs in FIG. 7) and applies a corresponding filter at each of those locations. For example, the filter bank may properly place a filter so that it keeps the only replica of interest for every RB, prior to superposition. The filter bank stage 818 then superimposes the M signals (e.g., M oversampled signals) and outputs a BF-OFDM waveform 822 to be amplified for transmission. In some aspects, the resulting BF-OFDM waveform may have characteristics similar to a conventional (e.g., non block-filtered) OFDM waveform.

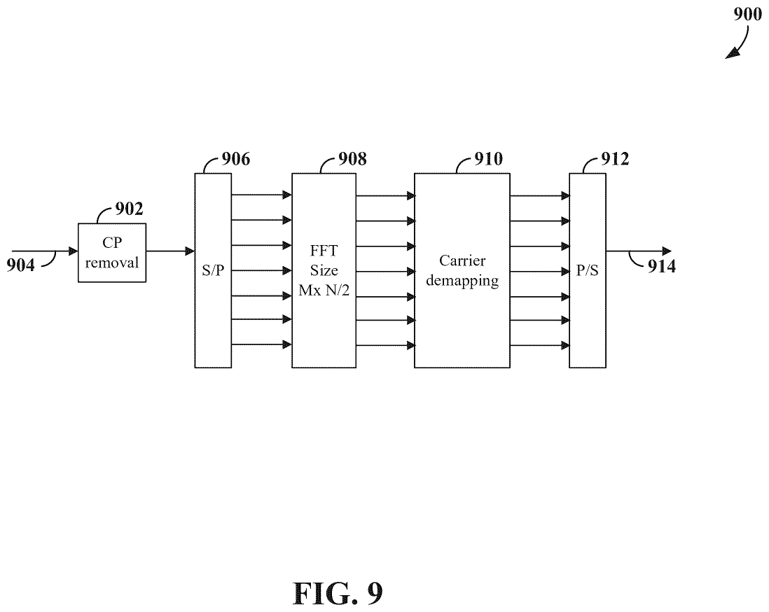

FIG. 9 illustrates an example of a receiver 900 that can receive an BF-OFDM waveform. In some examples, the receiver 900 may take the same form as a receiver that can receive a conventional (e.g., non block-filtered) OFDM waveform.

A CP removal module 902 removes a CP from a received serial time domain signal 904. The CP removal module 902 provides the resulting signal to a serial-to-parallel (S/P) converter 906 that converts the serial signal to parallel signals and provides the resulting signals to an FFT module 908. In some examples, the FFT module 908 computes the DFT of a sequence. For example, the FFT module 908 converts the parallel time domain signals to frequency domain signals. The FFT module 908 provides the resulting signals to a carrier demapping module 910 (e.g., that performs subcarrier de-mapping to produce a plurality of modulation symbols and may demodulate the modulation symbols to recover the encoded bits). The carrier demapping module 910 provides the resulting parallel frequency domain signals to a P/S converter 912 that converts parallel signals to serial frequency domain signals 914.

In BF-OFDM, for RB-level filtering, the processing of every RB (e.g., as shown in FIG. 8) entails an IDFT of a 24-point sequence (discrete frequency domain sequence to discrete time domain sequence), and an alternating allocation of symbols in the frequency domain via a rule based on the RB index parity. As one consequence, the time domain resolution for CP dimensioning is constrained to be inversely related to the size of such IDFT (e.g., equal to twice the PRB size), unlike regular OFDM where the CP is allocated with a resolution of one sample. As a result, the NR CP length might not be an integer multiple of samples.

As another consequence, there are further related complexity issues. For example, the complexity of the algorithm scales with a 24-point IDFT, which might not be implementable using a radix-2 IFFT implementation. While mixed radix implementations do exist, it is desirable to employ a radix-2 FFT/IFFT whenever possible due to the efficiencies provided by such an implementation. As a further consequence, up-sampling may be required for conversion to a power-of-2 in compliance with efficient FFT-based OFDM architectures.

The disclosure relates to a modified BF-OFDM architecture (e.g., that can provide RB-level filtering) that differs in some aspects from the BF-OFDM architecture described above in conjunction with FIGS. 7-9. In some aspects, the modified BF-OFDM architecture employs frequency allocation that can be represented as a circular shift to the IDFT input vector, rather than a frequency allocation that depends on the RB index parity as in the example of FIGS. 7 and 8. In the modified BF-OFDM architecture, different IDFT sizes (e.g., greater than 24) may be employed (e.g., based on how the circular shift is implemented). For example, a power-of-2 IDFT size may be employed.

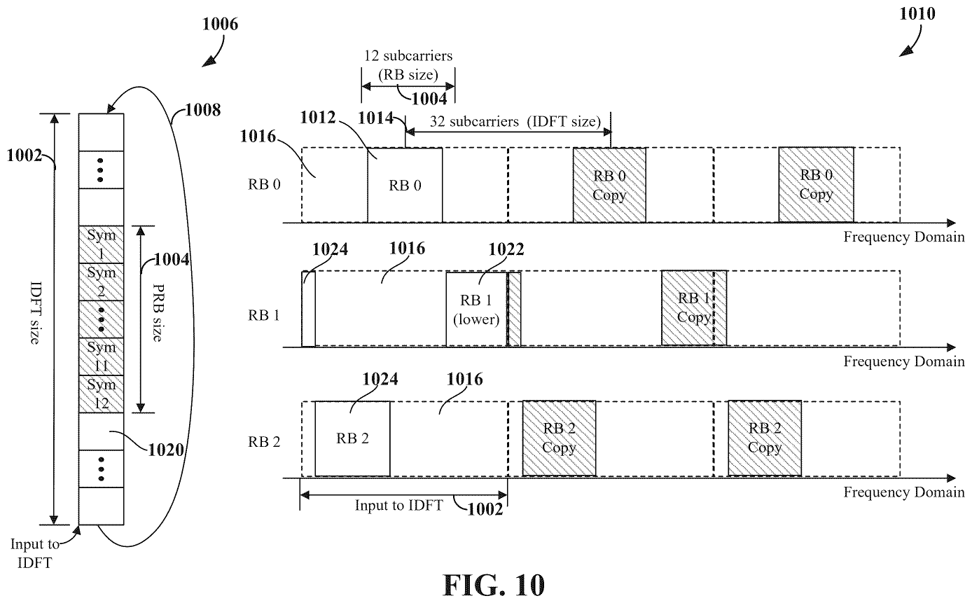

FIG. 10 illustrates an example of such a circular shift approach. Again, the frequency domain corresponds to the x-axis. In this example, the size of the input 1002 to an IDFT module for the BF-OFDM waveform generation corresponds to 32. The RB size 1004 is again 12 subcarriers in this case. In some examples, the RB size boundaries may be aligned with the beginning and end of RB 0 shown in FIG. 10.

As represented by a first diagram 1006, the RB input (symbols 1-12) for the IDFT are subject to a circular shift 1008 for each successive RB. In the example of FIG. 10, an initial RB position may be at the center of the frequency allocation as shown in the first diagram 1006.

This initial positioning is further illustrated in a second diagram 1010 of FIG. 10 which shows RB 0 1012 placed at the center 1014 of a frequency allocation 1016. The same holds true for each spectral copy of RB 0.

As further shown in the second diagram 1010, the position for the next RB, RB 1, in the frequency allocation 1016 is shifted to the right relative to RB 0 (e.g., shifted by the number of bits corresponding to the RB size). For example, symbol 1 for RB 1 may be at position 1020 in the first diagram 1006.

Since the IDFT size is 32 (i.e., 2⁵) in this example, the shift for RB 1 will result in RB 1 being split across the end of the frequency allocation 1016 and the beginning of the frequency allocation 1016. For example, the lower ten symbols of RB 1 are at position 1022 in the second diagram 1010 while the remaining upper two symbols of RB 1 are at position 1024 in the second diagram 1010. The same holds true for each spectral copy of RB 1.

As further shown in the second diagram 1010, the position for the next RB, RB 2, in the frequency allocation 1016 is shifted to the right relative to RB 1. The circular shift of the RBs will then continue for successive RBs (RB 3, RB 4, and so on).

By using the circular shift technique, allocations lower than 50% of the IDFT inputs are possible. For example, the IDFT size may be increased (e.g., to correspond to a power-of-two) while still allocating 12 subcarriers (SCs) (e.g., corresponding to a PRB size called for by 3GPP specifications and/or other specifications). In some aspects, the use of such a reduced allocation may provide more space (in frequency) for filter roll off within the frequency allocation 1016 (e.g., which may enable a filter to more effectively reject the spectral copies). The use of a reduced allocation (e.g., which may facilitate RB-level filtering) may be particularly applicable to implementations (e.g., NTNs) where different RBs are allocated to different users (e.g., RB 0 is allocated for communication between a satellite and a first user, RB 1 is allocated for communication between the satellite and a second user, and so on) since it may be desirable to reduce inter-RB interference in these cases. Furthermore, improved filter roll off performance may mitigate potential coexistence issues (e.g., by reducing interference between an NTN and a terrestrial network that are not tightly time synchronized). Allocations higher than 50% are also possible at the possible expense of an increased inter-carrier interference created by the transition band and roll-off of the corresponding filter (typically designed to be of, a so-called, Nyquist type). Also, the use of different IDFT sizes may provide increased flexibility. For example, the resolution of the CP may be increased or decreased (e.g., depending on different CP constraints in different implementations). Of note, an IDFT of size 128 may provide an integer number of samples for the CP (e.g., which may provide a smoother signal where the power is substantially constant at any given time instant). Moreover, such an IDFT size may leverage a CP having a length that matches a CP length called for in 3GPP specifications and/or other specifications. In some aspects, the use of a power-of-two IDFT size (e.g., which may enable the use of a radix-2 IFFT) may improve the efficiency of the IDFT operations (e.g., the processing time may be shorter and/or the power consumption may be lower).

Also, from FIG. 10 it may be observed that the use of a circular shift for a resource that is twice the size of the RB would provide essentially the same result that is shown in FIG. 7. Thus, in some aspects, the disclosed BF-OFDM architecture corresponds to a generalization of the per-RB frequency allocation strategy of the BF-OFDM described above in conjunction with FIGS. 7-9.

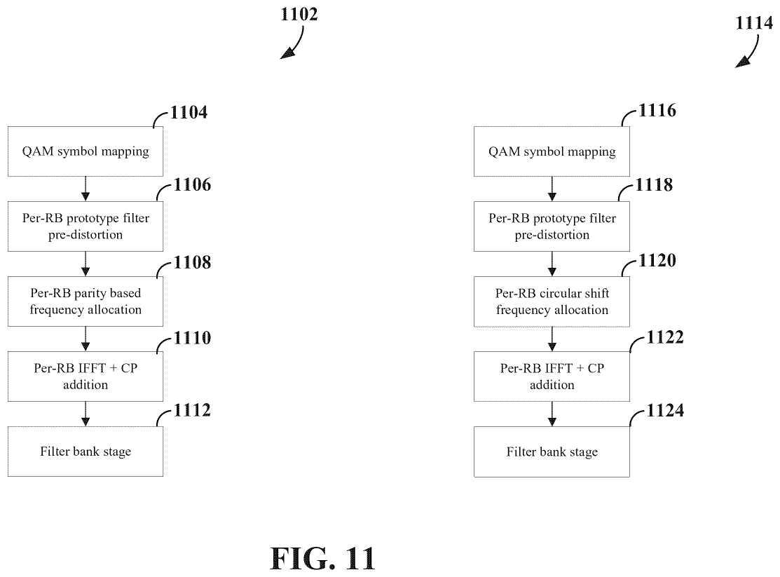

For purposes of further illustrations, FIGS. 11-13 describe some of the differences between the disclosed BF-OFDM architecture and the prior BF-OFDM architecture described above in conjunction with FIGS. 7-9.

FIG. 11 illustrates transmitter architectures that may be used for the prior BF-OFDM architecture and the disclosed BF-OFDM architecture. Other architectures may be used in other examples.

A first diagram 1102 of FIG. 11 illustrates an example of the transmitter architecture for the prior BF-OFDM architecture. As shown, a transmitter will perform quadrature amplitude modulation (QAM) symbol mapping 1104, per-RB prototype filter pre-distortion 1106, per-RB parity based frequency allocation 1108, per RB IFFT+CP addition 1110, followed by a filter bank stage 1112.

A second diagram 1114 of FIG. 11 illustrates an example of the transmitter architecture for the disclosed BF-OFDM architecture. As shown, a transmitter may perform QAM symbol mapping 1116, per-RB prototype filter pre-distortion 1118, per RB IFFT+CP addition 1122, followed by a filter bank stage 1124 similar to the QAM symbol mapping 1104, per-RB prototype filter pre-distortion 1106, per RB IFFT+CP addition 1110, and a filter bank stage 1112 of the first diagram 1102, respectively. However, in this case, the transmitter performs a per RB circular shift allocation 1120 instead of the per-RB parity based frequency allocation 1108.

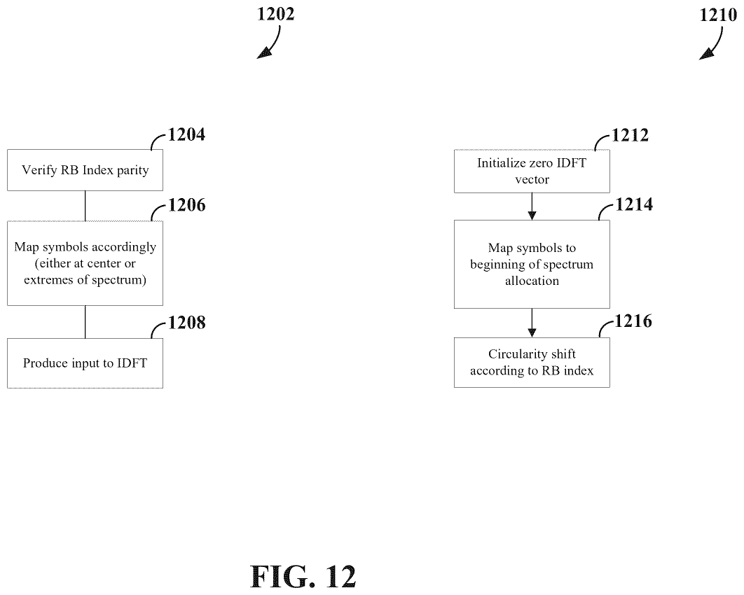

FIG. 12 illustrates an overview of frequency allocation operations that may be used for the prior BF-OFDM architecture and the disclosed BF-OFDM architecture. Other operations may be used in other examples.

A first diagram 1202 of FIG. 12 illustrates an example of the frequency allocation in the prior BF-OFDM architecture. As shown, a transmitter will verify the parity of an RB index 1204, map symbols according to the parity 1206, and provide the corresponding input to the IDFT 1208.

A second diagram 1210 of FIG. 12 illustrates an example of the frequency allocation in the disclosed BF-OFDM architecture. As shown, a transmitter may initialize a zero IDFT vector 1212, map symbols to the beginning of the spectrum allocation 1214, and perform a circular shift according to the RB index 1216.

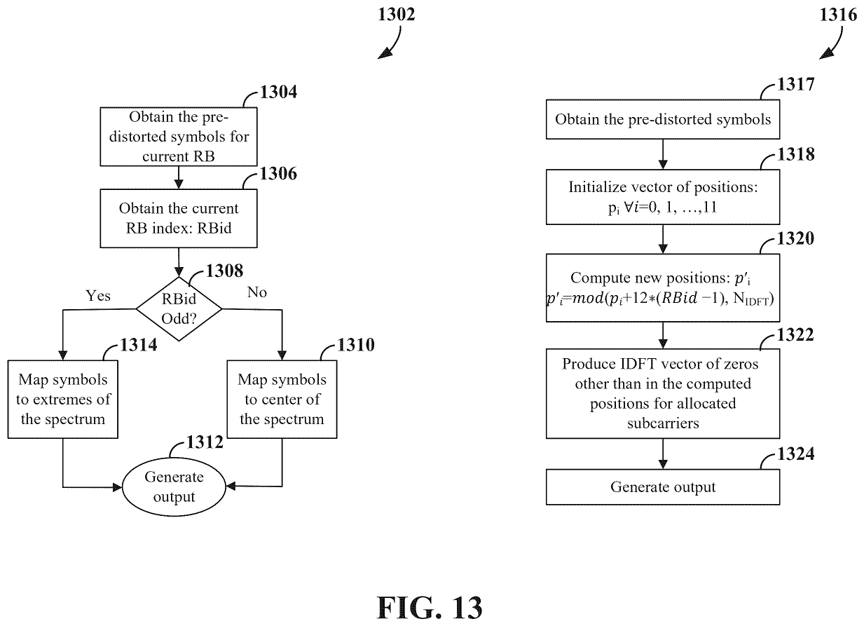

FIG. 13 illustrates more detailed examples of frequency allocation operations that may be used for the prior BF-OFDM architecture and the disclosed BF-OFDM architecture. Other operations may be used in other examples.

A first diagram 1302 of FIG. 13 illustrates an example of the frequency allocation in the prior BF-OFDM architecture. As shown, a transmitter will obtain the pre-distorted symbols for the current RB 1304, obtain the current RB index (RBid) 1306, and determine whether RBid is odd or even 1308. If RBid is even, the transmitter maps the symbols for the current RB to the center of the spectrum 1310 and generates a corresponding output to be transmitted 1312. On the other hand, if RBid is odd, the transmitter maps the symbols for the current RB to the extremes of the spectrum 1314 and generates a corresponding output to be transmitted 1312.

A second diagram 1316 of FIG. 13 illustrates an example of the frequency allocation in the disclosed BF-OFDM architecture. As shown, a transmitter may, as a preliminary operation, obtain the pre-distorted symbols 1317 and initialize a vector of positions (e.g., for the 12 subcarriers of the RB) 1318. For example, in FIG. 10, the initial positions for the first RB may correspond to the 12 subcarriers shown for RB 0 1012. Then, for each RB, the transmitter may compute new data positions for the IDFT inputs for allocated subcarriers 1320 (e.g., based on a shift according to a modulo operation using the current RBid), and produce an IDFT vector of zeros for the IDFT inputs other than those in the above computed positions for allocated subcarriers 1322. The transmitter thereby generates an output to be transmitted 1324. In the computation of the new positions for allocated subcarriers 1320, the mod( ) operation corresponds to the modulus after division, or x−floor(x/y)*y.

Through the use of the disclosed techniques, power amplifier efficiency may be increased as compared to other techniques. For example, the average power of a signal may increase with the reduction of empty samples that results from the improved time resolution for CP placement. Consequently, a relative reduction in peak-to-average power patio (PAPR) may be achieved.

Increasing the IDFT size to a power-of-two may provide computational complexity savings as well (e.g., up to 70%, for example). For example, a radix-2 IFFT may be employed (e.g., which may reduce complexity), with gains depending on the DFT/FFT implementations.

In addition, a reduction in complexity may result from avoiding up-sampling that may otherwise be required to match a power-of-two FFT size. Thus, for example, up-sampling from a 24 point IDFT to a power-of-two as may be employed in other BF-OFDM implementations would not be needed.

Increasing the IDFT size (and thus the time resolution) may be desirable to more closely match desired CP lengths (e.g., called for by 3GPP specifications and/or other specifications) and to reduce the number of empty samples. In some aspects, this may be important to comply with current time alignment (transparent receiver) requirements.

Increasing the IDFT size may also reduce inter-carrier interference (ICI). For example, a longer IDFT size may result in a larger distance between RB replicas prior to filtering which, in turn, may the lower the ICI.

In some examples, signaling from a network entity (e.g., a gNB) may be used to configure an IDFT size (e.g., a minimum IDFT size). Such signaling may be carried by an RRC message or some other type of signaling.

Also, in some examples, a wireless communication device (e.g., a UE) may signal that it is supports the use of a configurable IDFT size. Such signaling may be carried by an RRC message (e.g., a capability message) or some other type of signaling.

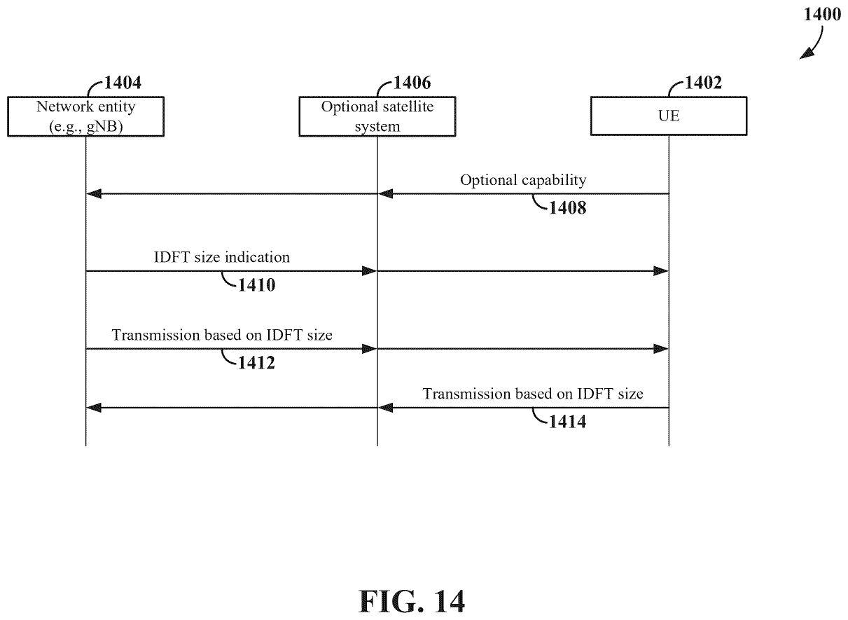

FIG. 14 is a signaling diagram 1400 illustrating an example of BF-OFDM related signaling in a wireless communication system including a user equipment 1402, a network entity 1404, and an optional satellite communication system 1406 (e.g., for a scenario where the user equipment 1402 is served by a satellite). In some examples, the user equipment 1402 may correspond to any of the UEs, CPEs, relay devices, or scheduled entities shown in any of FIGS. 1, 2, 3, 4, 5, 8, 9, 15, and 17. In some examples, the network entity 1404 may correspond to any of the network entities, base stations, CUs, DUs, RUs, or scheduling entities shown in any of FIGS. 1, 2, 3, 4, 5, 8, 9, and 15. In some examples, the satellite communication system 1406 may correspond to any of the satellites, gateways, ground networks, core network entities, external data network entities, and so on, shown in any of FIGS. 1, 2, 3, 4, 5, 8, 9, and 15.

At optional #1408 of FIG. 14, the user equipment 1402 may send a message to the network entity 1404 that indicates at least one capability of the user equipment 1402 (e.g., that the user equipment 1402 supports the use of a configurable IDFT size). This message may be an RRC message (e.g., a capability message) or some other type of message. In some examples, the message indicates that the user equipment 1402 has the capability to handle a configurable IDFT size for transmission operations and/or reception operations. In scenarios where the user equipment 1402 is served by a satellite, this message may be relayed to the network entity 1404 by the satellite communication system 1406. In some examples, the indication sent at 1410 may indicate that the user equipment 1402 supports filtering at a particular level (e.g., RB-level filtering).

At #1410, the network entity 1404 may send an indication of an IDFT size to the user equipment 1402. For example, the indication may indicate a minimum IDFT size, a specific IDFT size that will be used for subsequent transmissions and/or receptions, a specific IDFT size that will be used for a particular transmission and/or reception, or some other IDFT size related information. In scenarios where the user equipment 1402 is served by a satellite, this message may be relayed to the user equipment 1402 by the satellite communication system 1406. In some examples, the indication sent at 1410 may request filtering at a particular level (e.g., RB-level filtering). In this case, the user equipment 1402 may select a particular IDFT size (e.g., an IDFT size that is greater than twice the RB size) based on this indication.

At #1412, at some point in time, the network entity 1404 may transmit a transmission using an IDFT size that is based on the IDFT size indicated at #1410. For example, a transmitter of the network entity 1404 may employ BF-OFDM as taught herein (e.g., using a power-of-two IDFT size and/or circular shift based frequency allocation). In scenarios where the user equipment 1402 is served by a satellite, this message may be relayed to the user equipment 1402 by the satellite communication system 1406.

At #1414, at some point in time, the user equipment 1402 may transmit a transmission using an IDFT size that is based on the IDFT size indicated at #1410. For example, a transmitter of the user equipment 1402 may employ BF-OFDM as taught herein (e.g., using a power-of-two IDFT size and/or circular shift based frequency allocation). In scenarios where the user equipment 1402 is served by a satellite, this message may be relayed to the network entity 1404 by the satellite communication system 1406.

FIG. 15 is a block diagram illustrating an example of a hardware implementation for an apparatus 1500 employing a processing system 1514. In some examples, the apparatus 1500 may be a wireless node (e.g., a network entity). In some implementations, the apparatus 1500 may correspond to any of the network entities, CUs, DUs, RUs, base stations, or scheduling entities shown in any of FIGS. 1, 2, 3, 4, 5, 8, 9, and 14. In some implementations, the apparatus 1500 may correspond to any of the UEs or scheduled entities shown in any of FIGS. 1, 2, 3, 4, 5, 8, 9, 14, and 17 (e.g., to implement the techniques described herein in a peer-to-peer or customer premises equipment (CPE) configuration in conjunction with the apparatus 1500, where the downlink signaling and/or the uplink signaling (e.g., DCI, PDSCH, and so on) referred to herein may be designated in a more general manner (e.g., control information, a shared channel, and so on). In various implementations, the apparatus 1500 may include or implement one or more of the components and/or functions described above in conjunction with FIG. 8 14.

In accordance with various aspects of the disclosure, an element, or any portion of an element, or any combination of elements may be implemented with the processing system 1514. The processing system 1514 may include one or more processors (referred to herein as the processor 1504, for convenience). Examples of processors 1504 include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. In various examples, the apparatus 1500 may be configured to perform any one or more of the functions described herein. That is, the processor 1504, as utilized in an apparatus 1500, may be used to implement any one or more of the processes and procedures described herein.

In this example, the processing system 1514 may be implemented with a bus architecture, represented generally by the bus 1502. The bus 1502 may include any number of interconnecting buses and bridges depending on the specific application of the processing system 1514 and the overall design constraints. The bus 1502 communicatively couples together various circuits including one or more processors (represented generally by the processor 1504), one or more memories (referred to herein as the memory 1505, for convenience), and one or more computer-readable media (represented generally by the computer-readable medium 1506). The bus 1502 may also link various other circuits such as timing sources, peripherals, voltage regulators, and power management circuits, which are well known in the art, and therefore, will not be described any further. A bus interface 1508 provides an interface between the bus 1502, a transceiver 1510 and an antenna array 1520 and between the bus 1502 and an interface 1530. The transceiver 1510 provides a communication interface or means for communicating with various other apparatus over a wireless transmission medium. The interface 1530 provides a communication interface or means of communicating with various other apparatuses and devices (e.g., other devices housed within the same apparatus as the apparatus 1500 or other external apparatuses) over an internal bus or external transmission medium, such as an Ethernet cable.

The processor 1504 is responsible for managing the bus 1502 and general processing, including the execution of software stored on the computer-readable medium 1506. The software, when executed by the processor 1504, causes the processing system 1514 to perform the various functions described below for any particular apparatus. The computer-readable medium 1506 and the memory 1505 may also be used for storing data that is manipulated by the processor 1504 when executing software. For example, the memory 1505 may store BF-OFDM related information 1515 (e.g., an IDFT size, etc.) used by the processor 1504 for the communication operations described herein.

One or more processors 1504 in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a computer-readable medium 1506.

The computer-readable medium 1506 may be a non-transitory computer-readable medium. A non-transitory computer-readable medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a card, a stick, or a key drive), a random access memory (RAM), a read only memory (ROM), a programmable ROM (PROM), an erasable PROM (EPROM), an electrically erasable PROM (EEPROM), a register, a removable disk, and any other suitable medium for storing software and/or instructions that may be accessed and read by a computer. The computer-readable medium 1506 may reside in the processing system 1514, external to the processing system 1514, or distributed across multiple entities including the processing system 1514. The computer-readable medium 1506 may be embodied in a computer program product. By way of example, a computer program product may include a computer-readable medium in packaging materials. Those skilled in the art will recognize how best to implement the described functionality presented throughout this disclosure depending on the particular application and the overall design constraints imposed on the overall system.

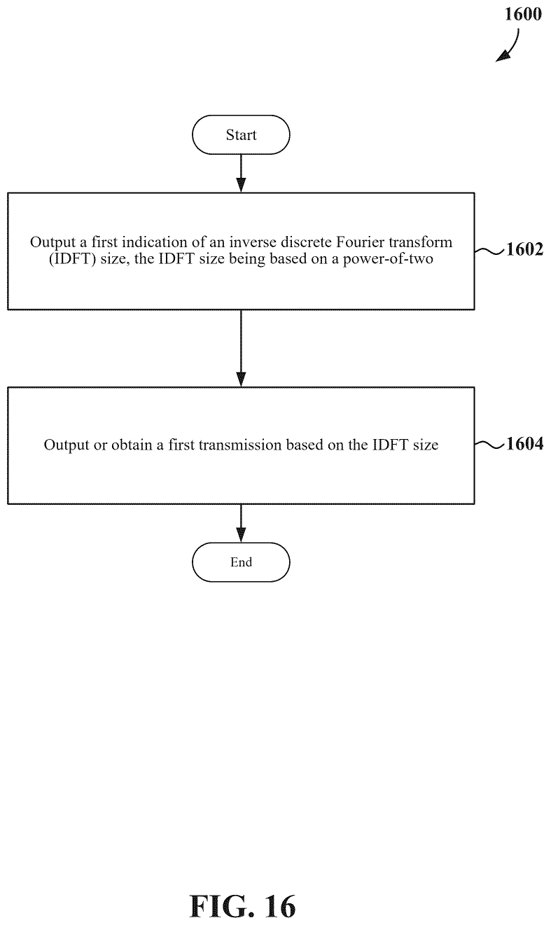

The apparatus 1500 may be configured to perform any one or more of the operations described herein (e.g., as described above in conjunction with FIGS. 1-14, and as described below in conjunction with FIG. 16). In some aspects of the disclosure, the processor 1504, as utilized in the apparatus 1500, may include circuitry configured for various functions.

The processor 1504 may be configured to generate, schedule, and modify a resource assignment or grant of time-frequency resources (e.g., a set of one or more resource elements). For example, the processor 1504 may schedule time-frequency resources within a plurality of time division duplex (TDD), frequency division duplex (FDD), SBFD, and/or full-duplex (FD) subframes, slots, and/or mini-slots to carry user data traffic and/or control information to and/or from multiple UEs.

The processor 1504 may be configured to schedule resources for the transmission of sidelink signals, downlink signals, or uplink signals. The processor 1504 may be configured to schedule resources for control information (e.g., DCI) operations.

The processor 1504 may in some instances be implemented via a baseband or modem chip and in other implementations, the processor 1504 may itself include a number of devices distinct and different from a baseband or modem chip (e.g., in such scenarios these devices may work in concert to achieve examples discussed herein). And as mentioned above, various hardware arrangements and components outside of a baseband modem processor can be used in implementations, including RF-chains, power amplifiers, modulators, buffers, interleavers, adders/summers, etc.

In some examples (e.g., for SL or CPE operations), the processor 1504 may be configured to generate, schedule, and modify a resource assignment or grant of time-frequency resources (e.g., a set of one or more resource elements). For example, the processor 1504 may schedule time-frequency resources within a plurality of time division duplex (TDD), frequency division duplex (FDD), SBFD, and/or FD subframes, slots, and/or mini-slots to carry user data traffic and/or control information to and/or from multiple UEs.

The processor 1504 may be configured to schedule resources for the transmission of sidelink signals. The processor 1504 may further be configured to send a scheduling request or a sidelink grant.

In some aspects of the disclosure, the processor 1504 may include communication and processing circuitry 1541. The communication and processing circuitry 1541 may be configured to communicate with network entities, UE, and/or other wireless devices. The communication and processing circuitry 1541 may include one or more hardware components that provide the physical structure that performs various processes related to communication (e.g., signal reception and/or signal transmission) as described herein. The communication and processing circuitry 1541 may further include one or more hardware components that provide the physical structure that performs various processes related to signal processing (e.g., processing a received signal and/or processing a signal for transmission) as described herein. The communication and processing circuitry 1541 may further be configured to execute communication and processing software 1551 included on the computer-readable medium 1506 to implement one or more functions described herein.

The communication and processing circuitry 1541 may further be configured to send or receive an indication. For example, the indication may be included in a MAC-CE carried in a Uu PUSCH, Uu PDSCH, or a PSCCH, or included in a Uu RRC message or an SL RRC message.

In some implementations where the communication involves receiving information, the communication and processing circuitry 1541 may obtain information from a component of the apparatus 1500 (e.g., from the transceiver 1510 that receives the information via radio frequency signaling or some other type of signaling suitable for the applicable communication medium), process (e.g., decode) the information, and output the processed information. For example, the communication and processing circuitry 1541 may output the information to another component of the processor 1504, to the memory 1505, or to the bus interface 1508. In some examples, the communication and processing circuitry 1541 may receive one or more of signals, messages, other information, or any combination thereof. In some examples, the communication and processing circuitry 1541 may receive information via one or more channels. In some examples, the communication and processing circuitry 1541 may receive one or more of signals, messages, SCIs, feedback, other information, or any combination thereof. In some examples, the communication and processing circuitry 1541 may receive information via one or more of a PSCCH, a PSSCH, a PSFCH, some other type of channel, or any combination thereof. In some examples, the communication and processing circuitry 1541 may include functionality for a means for obtaining (e.g., means for obtaining an indication, means for obtaining a transmission, means for obtaining a configuration, etc.). In some examples, the communication and processing circuitry 1541 and/or the transceiver 1510 may include functionality for a means for receiving (e.g., means for receiving an indication, means for receiving a transmission, means for receiving a configuration, etc.). In some examples, the communication and processing circuitry 1541 may include functionality for a means for decoding. In some examples, the communication and processing circuitry 1541 may include functionality for a means for receiving information (e.g., an indication, data, etc.) from a UE.

In some implementations where the communication involves sending (e.g., transmitting) information, the communication and processing circuitry 1541 may obtain information (e.g., from another component of the processor 1504, the memory 1505, or the bus interface 1508), process (e.g., encode) the information, and output the processed information. For example, the communication and processing circuitry 1541 may output the information to the transceiver 1510 (e.g., that transmits the information via radio frequency signaling or some other type of signaling suitable for the applicable communication medium). In some examples, the communication and processing circuitry 1541 may send one or more of signals, messages, other information, or any combination thereof. In some examples, the communication and processing circuitry 1541 may send information via one or more channels. In some examples, the communication and processing circuitry 1541 may send one or more of signals, messages, feedback, other information, or any combination thereof. In some examples, the communication and processing circuitry 1541 may send information via one or more of a PSCCH, a PSSCH, a PSFCH, some other type of channel, or any combination thereof. In some examples, the communication and processing circuitry 1541 may include functionality for a means for outputting (e.g., means for outputting an indication, means for outputting a transmission, etc.). In some examples, the communication and processing circuitry 1541 and/or the transceiver 1510 may include functionality for a means for transmitting (e.g., means for transmitting an indication, means for transmitting a transmission, etc.). In some examples, the communication and processing circuitry 1541 may include functionality for a means for encoding. In some examples, the communication and processing circuitry 1541 may include functionality for a means for transmitting information to a UE.

The processor 1504 may include BF-OFDM configuration circuitry 1542 configured to perform BF-OFDM configuration-related operations as discussed herein (e.g., one or more of the operations described above in conjunction with FIGS. 1-14). The BF-OFDM configuration circuitry 1542 may be configured to execute BF-OFDM configuration software 1552 included on the computer-readable medium 1506 to implement one or more functions described herein.

The BF-OFDM configuration circuitry 1542 may include functionality for a means for outputting (e.g., as described above in conjunction with FIGS. 1-14). For example, the BF-OFDM configuration circuitry 1542 may cause a first transmission that is based on an IDFT size to be output for transmission. As another example, the BF-OFDM configuration circuitry 1542 may output an indication (e.g., for transmission to a second apparatus). In some examples, the indication may indicate an IDFT size.

The BF-OFDM configuration circuitry 1542 may include functionality for a means for obtaining (e.g., as described above in conjunction with FIGS. 1-14). For example, the BF-OFDM configuration circuitry 1542 may obtain information (e.g., an indication, scheduling information, etc.) from another component of the apparatus 1500. As another example, the BF-OFDM configuration circuitry 1542 may obtain (e.g., receive) information (e.g., an indication, etc.) from a UE (e.g., via a PUCCH, a PUSCH, etc.) via the transceiver 1510. In some examples, the indication may indicate a capability of a second apparatus to support use of a configurable IDFT size for transmission operations and/or reception operations.

The processor 1504 may include BF-OFDM processing circuitry 1543 configured to perform BF-OFDM processing-related operations as discussed herein (e.g., one or more of the operations described above in conjunction with FIGS. 1-14). The BF-OFDM processing circuitry 1543 may be configured to execute BF-OFDM processing software 1553 included on the computer-readable medium 1506 to implement one or more functions described herein.

The BF-OFDM processing circuitry 1543 may include functionality for a means for generating (e.g., as described above in conjunction with FIGS. 1-14). For example, the BF-OFDM processing circuitry 1543 may generate a first transmission (e.g., based on a circular shift, within a frequency allocation, of successive resource block inputs for an IDFT).

The BF-OFDM processing circuitry 1543 may include functionality for a means for obtaining (e.g., as described above in conjunction with FIGS. 1-14). For example, the BF-OFDM processing circuitry 1543 may obtain information (e.g., originating from a UE, etc.) from another component of the apparatus 1500. The BF-OFDM processing circuitry 1543 may obtain a first transmission (e.g., based on a circular shift, within a frequency allocation, of successive resource block inputs for an IDFT). The BF-OFDM processing circuitry 1543 may obtain a first transmission based on a configurable IDFT size.

The BF-OFDM processing circuitry 1543 may include functionality for a means for outputting (e.g., as described above in conjunction with FIGS. 1-14). For example, the BF-OFDM processing circuitry 1543 may output information to another component of the apparatus 1500 (e.g., for transmission to a second apparatus). The BF-OFDM processing circuitry 1543 may output a first transmission (e.g., based on a circular shift, within a frequency allocation, of successive resource block inputs for an IDFT). The BF-OFDM processing circuitry 1543 may output a first transmission based on a configurable IDFT size.

In some examples, the apparatus 1500 shown and described above in connection with FIG. 15 may be a disaggregated base station. For example, the apparatus 1500 shown in FIG. 15 may include the CU and optionally one or more DUs/RUs of the disaggregated base station. Other DUs/RUs associated with the apparatus 1500 may be distributed throughout the network. In some examples, the DUs/RUs may correspond to TRPs associated with the network entity. In some examples, the CU and/or DU/RU of the disaggregated base station (e.g., within the apparatus 1500) may generate information and send the information to a UE.

FIG. 16 is a flow chart illustrating an example method 1600 for communication in accordance with some aspects of the present disclosure. As described below, some or all illustrated features may be omitted in a particular implementation within the scope of the present disclosure, and some illustrated features may not be required for implementation of all examples. In some examples, the method 1600 (e.g., a method for wireless communication) may be carried out by the apparatus 1500 illustrated in FIG. 15, the apparatus 402 illustrated in FIG. 4, or a wireless node (e.g., a UE). In some examples, the method 1600 may be carried out by any suitable apparatus or means for carrying out the functions or algorithm described below.

At block 1602, a first apparatus may output a first indication of an inverse discrete Fourier transform (IDFT) size, the IDFT size being based on a power-of-two. In some examples, the BF-OFDM configuration circuitry 1542 and/or the communication and processing circuitry 1541 and/or the transceiver 1510, shown and described in FIG. 15, may provide a means to output a first indication of an inverse discrete Fourier transform (IDFT) size, the IDFT size being based on a power-of-two.

At block 1604, the first apparatus may output or obtain a first transmission based on the IDFT size. In some examples, BF-OFDM configuration circuitry 1542 and/or the BF-OFDM processing circuitry 1543 and/or the communication and processing circuitry 1541 and/or the transceiver 1510, shown and described in FIG. 15, may provide a means to output (e.g., for transmission to a second apparatus) or obtain a first transmission based on the IDFT size.

In some examples, the first transmission may include a block-filtered orthogonal frequency division multiplexing (BF-OFDM) signal based on the IDFT size.

In some examples, the first apparatus may generate the first transmission based on a circular shift, within a frequency allocation, of successive resource block inputs for an IDFT. In some examples, symbol allocation within the frequency allocation is less than fifty percent.

In some examples, a size of each resource block of the successive resource block inputs is 12 subcarriers. In some examples, a size of the frequency allocation is based on the IDFT size. In some examples, the IDFT size is 32 subcarriers, 64 subcarriers, or 128 subcarriers.

In some examples, the first indication specifies a minimum IDFT size. In some examples, the first transmission may include a block-filtered orthogonal frequency division multiplexing (BF-OFDM) signal that is based on another IDFT size that is larger than the minimum IDFT size and further based on the power-of-two.

In some examples, the first indication specifies a minimum IDFT size. In some examples, the first indication specifies a specific IDFT size to be used for multiple transmissions. In some examples, the first indication specifies a specific IDFT size to be used for the first transmission.

In some examples, the first apparatus may obtain a second indication of a capability of a second apparatus to support use of a configurable IDFT size. In some examples, the first indication is output based on the second indication (e.g., the first apparatus elects to output the first indication upon determining that the second apparatus supports the use of a configurable IDFT size).

In some examples, the first apparatus may include a transceiver configured to transmit the first indication and transmit or receive the first transmission, wherein the first apparatus is configured as a network entity.

Referring again to FIG. 15, in one configuration, the apparatus 1500 includes means for outputting a first indication of an inverse discrete Fourier transform (IDFT) size, the IDFT size being based on a power-of-two, and means for outputting or obtaining a first transmission based on the IDFT size. In one aspect, the aforementioned means may be the processor 1504 shown in FIG. 15 configured to perform the functions recited by the aforementioned means (e.g., as discussed above). In another aspect, the aforementioned means may be a circuit or any apparatus configured to perform the functions recited by the aforementioned means.

Of course, in the above examples, the circuitry included in the processor 1504 is merely provided as an example, and other means for carrying out the described functions may be included within various aspects of the present disclosure, including but not limited to the instructions stored in the computer-readable medium 1506, or any other suitable apparatus or means described in any of FIGS. 1, 2, 3, 4, 5, 8, 9, 14, and 15, and utilizing, for example, the methods and/or algorithms described herein in relation to FIG. 16.

FIG. 17 is a conceptual diagram illustrating an example of a hardware implementation for an apparatus 1700 employing a processing system 1714. In some examples, the apparatus 1700 may be a device such as a wireless node (e.g., a UE) configured to wirelessly communicate in a network as discussed in any of FIGS. 1-14. In some implementations, the apparatus 1700 may correspond to any of the UEs, sidelink devices, D2D devices, or scheduled entities shown in any of FIGS. 1, 2, 3, 4, 5, 8, 9, 14, and 15. In various implementations, the apparatus 1700 may include or implement one or more of the components and/or functions described above in conjunction with FIG. 8 14.

In accordance with various aspects of the disclosure, an element, or any portion of an element, or any combination of elements may be implemented with the processing system 1714. The processing system may include one or more processors (referred to herein as the processor 1704, for convenience). The processing system 1714 may be substantially the same as the processing system 1514 illustrated in FIG. 15, including a bus interface 1708, a bus 1702, one or more memories (referred to herein as the memory 1705, for convenience), a processor 1704, a computer-readable medium 1706, a transceiver 1710, and an antenna array 1720. The memory 1705 may store BF-OFDM related information 1715 (e.g., an IDFT size, etc.) used by the processor 1704 in cooperation with the transceiver 1710 for communication operations as described herein. Furthermore, the apparatus 1700 may include an interface 1730 (e.g., a network interface) that provides a means for communicating with at least one other apparatus within a core network and with at least one radio access network. Depending upon the nature of the apparatus, the interface 1730 may include a user interface (e.g., keypad, display, speaker, microphone, joystick). Of course, such a user interface is optional, and may be omitted in some examples, such as an IoT device.

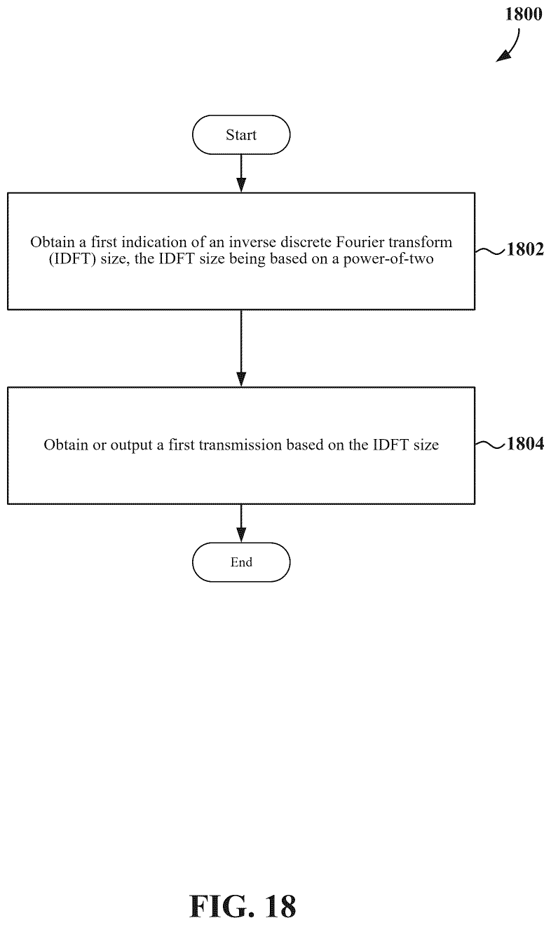

The apparatus 1700 may be configured to perform any one or more of the operations described herein (e.g., as described above in conjunction with FIGS. 1-14 and as described below in conjunction with FIG. 18). In some aspects of the disclosure, the processor 1704, as utilized in the apparatus 1700, may include circuitry configured for various functions.

The processor 1704 may in some instances be implemented via a baseband or modem chip and in other implementations, the processor 1704 may itself include a number of devices distinct and different from a baseband or modem chip (e.g., in such scenarios these devices may work in concert to achieve examples discussed herein). And as mentioned above, various hardware arrangements and components outside of a baseband modem processor can be used in implementations, including RF-chains, power amplifiers, modulators, buffers, interleavers, adders/summers, etc.

In some examples (e.g., for SL or CPE operations), the processor 1704 may be configured to generate, schedule, and modify a resource assignment or grant of time-frequency resources (e.g., a set of one or more resource elements). For example, the processor 1704 may schedule time-frequency resources within a plurality of time division duplex (TDD), frequency division duplex (FDD), SBFD, and/or FD subframes, slots, and/or mini-slots to carry user data traffic and/or control information to and/or from multiple UEs.

The processor 1704 may be configured to schedule resources for the transmission of sidelink signals. The processor 1704 may further be configured to send a scheduling request or a sidelink grant.

In some aspects of the disclosure, the processor 1704 may include communication and processing circuitry 1741. The communication and processing circuitry 1741 may be configured to communicate with UEs and/or network entities. The communication and processing circuitry 1741 may include one or more hardware components that provide the physical structure that performs various processes related to communication (e.g., signal reception and/or signal transmission) as described herein. The communication and processing circuitry 1741 may further include one or more hardware components that provide the physical structure that performs various processes related to signal processing (e.g., processing a received signal and/or processing a signal for transmission) as described herein. The communication and processing circuitry 1741 may further be configured to execute communication and processing software 1751 included on the computer-readable medium 1706 to implement one or more functions described herein.

In some implementations wherein the communication involves receiving information, the communication and processing circuitry 1741 may obtain information from a component of the apparatus 1700 (e.g., from the transceiver 1710 that receives the information via radio frequency signaling or some other type of signaling suitable for the applicable communication medium), process (e.g., decode) the information, and output the processed information. For example, the communication and processing circuitry 1741 may output the information to another component of the processor 1704, to the memory 1705, or to the bus interface 1708. In some examples, the communication and processing circuitry 1741 may receive one or more of signals, messages, other information, or any combination thereof. In some examples, the communication and processing circuitry 1741 may receive information via one or more channels. In some examples, the communication and processing circuitry 1741 and/or the transceiver 1710 may include functionality for a means for receiving (e.g., means for receiving an indication, means for receiving a transmission, etc.). In some examples, the communication and processing circuitry 1741 may include functionality for a means for obtaining (e.g., means for obtaining an indication, means for obtaining a transmission, etc.). In some examples, the communication and processing circuitry 1741 may include functionality for a means for decoding. In some examples, the communication and processing circuitry 1741 may include functionality for a means for receiving information from a network entity.

In some implementations wherein the communication involves sending (e.g., transmitting) information, the communication and processing circuitry 1741 may obtain information (e.g., from another component of the processor 1704, the memory 1705, or the bus interface 1708), process (e.g., encode) the information, and output the processed information. For example, the communication and processing circuitry 1741 may output the information to the transceiver 1710 (e.g., that transmits the information via radio frequency signaling or some other type of signaling suitable for the applicable communication medium). In some examples, the communication and processing circuitry 1741 may send one or more of signals, messages, other information, or any combination thereof. In some examples, the communication and processing circuitry 1741 may send information via one or more channels. In some examples, the communication and processing circuitry 1741 and/or the transceiver 1710 may include functionality for a means for transmitting (e.g., means for transmitting a transmission, means for transmitting an indication, etc.). In some examples, the communication and processing circuitry 1741 may include functionality for a means for outputting (e.g., means for outputting a transmission, means for outputting an indication, etc.). In some examples, the communication and processing circuitry 1741 may include functionality for a means for encoding. In some examples, the communication and processing circuitry 1741 may include functionality for a means for transmitting information to a network entity.

The processor 1704 may include BF-OFDM configuration circuitry 1742 configured to perform BF-OFDM configuration-related operations as discussed herein (e.g., one or more of the operations described above in conjunction with FIGS. 1-14). The BF-OFDM configuration circuitry 1742 may be configured to execute BF-OFDM configuration software 1752 included on the computer-readable medium 1706 to implement one or more functions described herein.

The BF-OFDM configuration circuitry 1742 may include functionality for a means for outputting (e.g., as described above in conjunction with FIGS. 1-14). For example, the BF-OFDM configuration circuitry 1742 may output information (e.g., an indication, etc.) to another component of the apparatus 1700. As another example, the BF-OFDM configuration circuitry 1742 may output (e.g., transmit) information (e.g., an indication, etc.) to a network entity (e.g., via a PUCCH, a PUSCH, etc.) via the transceiver 1710. In some examples, the indication may indicate a capability of the apparatus 1700 to support use of a configurable IDFT size for transmission operations and/or reception operations. The BF-OFDM configuration circuitry 1742 may cause a first transmission that is based on an IDFT size to be output for transmission.

The BF-OFDM configuration circuitry 1742 may include functionality for a means for obtaining (e.g., as described above in conjunction with FIGS. 1-14). For example, the BF-OFDM configuration circuitry 1742 may obtain information (e.g., originating from a network entity, etc.) via another component of the apparatus 1700.

The processor 1704 may include BF-OFDM processing circuitry 1743 configured to perform BF-OFDM processing-related operations as discussed herein (e.g., one or more of the operations described above in conjunction with FIGS. 1-14). The BF-OFDM processing circuitry 1743 may be configured to execute BF-OFDM processing software 1753 included on the computer-readable medium 1706 to implement one or more functions described herein.

The BF-OFDM processing circuitry 1743 may include functionality for a means for generating (e.g., as described above in conjunction with FIGS. 1-14). For example, the BF-OFDM processing circuitry 1743 may generate a first transmission (e.g., based on a circular shift, within a frequency allocation, of successive resource block inputs for an IDFT).

The BF-OFDM processing circuitry 1743 may include functionality for a means for outputting (e.g., as described above in conjunction with FIGS. 1-14). For example, the BF-OFDM processing circuitry 1743 may output information to another component of the apparatus 1700. As another example, the BF-OFDM processing circuitry 1743 may output a message (e.g., including data, etc.) for transmission to at least one network entity (e.g., via a PUCCH, a PUSCH, etc.) or to at least one UE. The BF-OFDM processing circuitry 1743 may output a first transmission (e.g., based on a circular shift, within a frequency allocation, of successive resource block inputs for an IDFT). The BF-OFDM processing circuitry 1743 may output a first transmission based on a configurable IDFT size.

The BF-OFDM processing circuitry 1743 may include functionality for a means for obtaining (e.g., as described above in conjunction with FIGS. 1-14). For example, the BF-OFDM processing circuitry 1743 may obtain information from another component of the apparatus 1700. As another example, the BF-OFDM processing circuitry 1743 may obtain data originating from a network entity (e.g., via a PDSCH). The BF-OFDM processing circuitry 1743 may obtain a first transmission (e.g., based on a circular shift, within a frequency allocation, of successive resource block inputs for an IDFT). The BF-OFDM processing circuitry 1743 may obtain a first transmission based on a configurable IDFT size.

FIG. 18 is a flow chart illustrating an example method 1800 for wireless communication in accordance with some aspects of the present disclosure. As described below, some or all illustrated features may be omitted in a particular implementation within the scope of the present disclosure, and some illustrated features may not be required for implementation of all examples. In some examples, the method 1800 (e.g., a method for wireless communication) may be carried out by the apparatus 1700 illustrated in FIG. 17, the apparatus 402 illustrated in FIG. 4, or a wireless node (e.g., a network entity). In some examples, the method 1800 may be carried out by any suitable apparatus or means for carrying out the functions or algorithm described below.

At block 1802, a first apparatus may obtain a first indication of an inverse discrete Fourier transform (IDFT) size, the IDFT size being based on a power-of-two. In some examples, the BF-OFDM configuration circuitry 1742 and/or the communication and processing circuitry 1741 and/or the transceiver 1710, shown and described in FIG. 17, may provide a means to obtain a first indication of an inverse discrete Fourier transform (IDFT) size, the IDFT size being based on a power-of-two.

At block 1804, the first apparatus may obtain or output a first transmission based on the IDFT size. In some examples, BF-OFDM configuration circuitry 1742 and/or the BF-OFDM processing circuitry 1743 and/or the communication and processing circuitry 1741 and/or the transceiver 1710, shown and described in FIG. 17, may provide a means to obtain or output (e.g., for transmission to a second apparatus) a first transmission based on the IDFT size.

In some examples, the first transmission may include a block-filtered orthogonal frequency division multiplexing (BF-OFDM) signal based on the IDFT size.

In some examples, the first apparatus may generate the first transmission based on a circular shift, within a frequency allocation, of successive resource block inputs for an IDFT. In some examples, symbol allocation within the frequency allocation is less than fifty percent.

In some examples, the first transmission is based on a circular shift, within a frequency allocation, of successive resource block inputs for an IDFT. In some examples, symbol allocation within the frequency allocation is less than fifty percent.

In some examples, a size of each resource block of the successive resource block inputs is 12 subcarriers. In some examples, a size of the frequency allocation is based on the IDFT size. In some examples, the IDFT size is 32 subcarriers, 64 subcarriers, or 128 subcarriers.

In some examples, the first indication specifies a minimum IDFT size. In some examples, the first transmission may include a block-filtered orthogonal frequency division multiplexing (BF-OFDM) signal that is based on another IDFT size that is larger than the minimum IDFT size and further based on the power-of-two.

In some examples, the first indication specifies a minimum IDFT size. In some examples, the first indication specifies a specific IDFT size to be used for multiple transmissions. In some examples, the first indication specifies a specific IDFT size to be used for the first transmission.

In some examples, the first apparatus may output a second indication of a capability of the first apparatus to support use of a configurable IDFT size. In some examples, the first indication is obtained based on the second indication (e.g., the first indication is obtained after the second indication is output).

In some examples, the first apparatus may include a transceiver configured to receive the first indication and transmit or receive the first transmission, wherein the first apparatus is configured as a user equipment.

Referring again to FIG. 17, in one configuration, the apparatus 1700 includes means for obtaining a first indication of an inverse discrete Fourier transform (IDFT) size, the IDFT size being based on a power-of-two, and means for obtaining or outputting a first transmission based on the IDFT size. In one aspect, the aforementioned means may be the processor 1704 shown in FIG. 17 configured to perform the functions recited by the aforementioned means (e.g., as discussed above). In another aspect, the aforementioned means may be a circuit or any apparatus configured to perform the functions recited by the aforementioned means.

Of course, in the above examples, the circuitry included in the processor 1704 is merely provided as an example, and other means for carrying out the described functions may be included within various aspects of the present disclosure, including but not limited to the instructions stored in the computer-readable medium 1706, or any other suitable apparatus or means described in any of FIGS. 1, 2, 3, 4, 5, 8, 9, 14, 15, and 17, and utilizing, for example, the methods and/or algorithms described herein in relation to FIG. 18.

The methods shown in FIGS. 16 and 18 may include additional aspects, such as any single aspect or any combination of aspects described below and/or in connection with one or more other processes described elsewhere herein. The following provides an overview of several aspects of the present disclosure.
Aspect 1: A method for communication at a wireless node, the method comprising: outputting a first indication of an inverse discrete Fourier transform (IDFT) size, the IDFT size being based on a power-of-two; and outputting or obtaining a first transmission based on the IDFT size.
Aspect 2: The method of aspect 1, wherein the first transmission comprises a block-filtered orthogonal frequency division multiplexing (BF-OFDM) signal based on the IDFT size.
Aspect 3: The method of aspect 1 or 2, further comprising: generating the first transmission based on a circular shift, within a frequency allocation, of successive resource block inputs for an IDFT.
Aspect 4: The method of aspect 3, wherein symbol allocation within the frequency allocation is less than fifty percent.
Aspect 5: The method of any of aspects 3 through 4, wherein at least one of: a size of each resource block of the successive resource block inputs is 12 subcarriers; or a size of the frequency allocation is based on the IDFT size.
Aspect 6: The method of aspect 5, wherein the IDFT size is 32 subcarriers, 64 subcarriers, or 128 subcarriers.
Aspect 7: The method of any of aspects 1 through 6, wherein: the first indication specifies a minimum IDFT size; and the first transmission comprises a block-filtered orthogonal frequency division multiplexing (BF-OFDM) signal that is based on another IDFT size that is larger than the minimum IDFT size and further based on the power-of-two.
Aspect 8: The method of any of aspects 1 through 7, wherein the first indication specifies at least one of: a minimum IDFT size; a specific IDFT size to be used for multiple transmissions or receptions; or a specific IDFT size to be used for the first transmission.
Aspect 9: The method of any of aspects 1 through 8, further comprising: obtaining a second indication of a capability of a second apparatus to support use of a configurable IDFT size, wherein the first indication is output based on the second indication.
Aspect 10: The method of any of aspects 1 through 9, further comprising: transmitting the first indication and transmitting or receiving the first transmission, wherein the wireless node is configured as a network entity.
Aspect 11: A method for communication at a wireless node, the method comprising: obtaining a first indication of an inverse discrete Fourier transform (IDFT) size, the IDFT size being based on a power-of-two; and obtaining or outputting a first transmission based on the IDFT size.
Aspect 12: The method of aspect 11, wherein the first transmission comprises a block-filtered orthogonal frequency division multiplexing (BF-OFDM) signal based on the IDFT size.
Aspect 13: The method of any of aspects 11 through 12, further comprising: generating the first transmission based on a circular shift, within a frequency allocation, of successive resource block inputs for an IDFT.
Aspect 14: The method of aspect 13, wherein symbol allocation within the frequency allocation is less than fifty percent.
Aspect 15: The method of any of aspects 13 through 14, wherein at least one of: a size of each resource block of the successive resource block inputs is 12 subcarriers; or a size of the frequency allocation is based on the IDFT size.
Aspect 16: The method of aspect 15, wherein the IDFT size is 32 subcarriers, 64 subcarriers, or 128 subcarriers.
Aspect 17: The method of any of aspects 11 through 16, wherein: the first indication specifies a minimum IDFT size; and the first transmission comprises a block-filtered orthogonal frequency division multiplexing (BF-OFDM) signal that is based on another IDFT size that is larger than the minimum IDFT size and further based on the power-of-two.
Aspect 18: The method of any of aspects 11 through 17, wherein the first indication specifies at least one of: a minimum IDFT size; a specific IDFT size to be used for multiple transmissions or receptions; or a specific IDFT size to be used for the first transmission.
Aspect 19: The method of any of aspects 11 through 18, further comprising: outputting a second indication of a capability of the first apparatus to support use of a configurable IDFT size, wherein the first indication is obtained based on the second indication.
Aspect 20: The method of any of aspects 11 through 19, further comprising: receiving the first indication and receiving or transmitting the first transmission, wherein the wireless node is configured as a user equipment.
Aspect 21: A wireless node (e.g., a network entity), comprising: one or more transceivers; one or more memories that store processor-executable code; and one or more processors configured to execute the processor-executable code and cause the wireless node to perform a method in accordance with any one or more of aspects 1 through 9, wherein the one or more transceivers are configured to transmit the first indication and transmit or receive the first transmission.
Aspect 22: An apparatus configured for communication comprising at least one means for performing any one or more of aspects 1 through 10.
Aspect 23: A non-transitory computer-readable medium storing computer-executable code, comprising code for causing an apparatus to perform any one or more of aspects 1 through 10.
Aspect 24: An apparatus, comprising: one or more memories that store processor-executable code; and one or more processors configured to execute the processor-executable code and cause the apparatus to perform a method in accordance with any one or more of aspects 1 through 9.
Aspect 25: A first wireless node (e.g., a user equipment), comprising: one or more transceivers; one or more memories that store processor-executable code; and one or more processors configured to execute the processor-executable code and cause the first wireless node to perform a method in accordance with any one or more of aspects 11 through 19, wherein the one or more transceivers are configured to receive the first indication and receive or transmit the first transmission.
Aspect 26: An apparatus configured for communication comprising at least one means for performing any one or more of aspects 11 through 20.
Aspect 27: A non-transitory computer-readable medium storing computer-executable code, comprising code for causing an apparatus to perform any one or more of aspects 11 through 20.
Aspect 28: An apparatus, comprising: one or more memories that store processor-executable code; and one or more processors configured to execute the processor-executable code and cause the apparatus to perform a method in accordance with any one or more of aspects 11 through 19.

Several aspects of a wireless communication network have been presented with reference to an example implementation. As those skilled in the art will readily appreciate, various aspects described throughout this disclosure may be extended to other telecommunication systems, network architectures and communication standards.

By way of example, various aspects may be implemented within other systems defined by 3GPP, such as Long-Term Evolution (LTE), the Evolved Packet System (EPS), the Universal Mobile Telecommunication System (UMTS), and/or the Global System for Mobile (GSM). Various aspects may also be extended to systems defined by the 3rd Generation Partnership Project 2 (3GPP 2), such as CDMA 2000 and/or Evolution-Data Optimized (EV-DO). Other examples may be implemented within systems employing Institute of Electrical and Electronics Engineers (IEEE) 802.11 (Wi-Fi), IEEE 802.16 (WiMAX), IEEE 802.20, Ultra-Wideband (UWB), Bluetooth, and/or other suitable systems. The actual telecommunication standard, network architecture, and/or communication standard employed will depend on the specific application and the overall design constraints imposed on the system.

Within the present disclosure, the word “exemplary” is used to mean “serving as an example, instance, or illustration.” Any implementation or aspect described herein as “exemplary” is not necessarily to be construed as preferred or advantageous over other aspects of the disclosure. Likewise, the term “aspects” does not require that all aspects of the disclosure include the discussed feature, advantage or mode of operation. The term “coupled” is used herein to refer to the direct or indirect coupling between two objects. For example, if object A physically touches object B, and object B touches object C, then objects A and C may still be considered coupled to one another—even if they do not directly physically touch each other. For instance, a first object may be coupled to a second object even though the first object is never directly physically in contact with the second object. The terms “circuit” and “circuitry” are used broadly, and intended to include both hardware implementations of electrical devices and conductors that, when connected and configured, enable the performance of the functions described in the present disclosure, without limitation as to the type of electronic circuits, as well as software implementations of information and instructions that, when executed by a processor, enable the performance of the functions described in the present disclosure. As used herein, the term “determining” may include, for example, ascertaining, resolving, selecting, choosing, establishing, calculating, computing, processing, deriving, investigating, looking up (e.g., looking up in a table, a database or another data structure), and the like. Also, “determining” may include receiving (e.g., receiving information), accessing (e.g., accessing data in a memory), and the like.

One or more of the components, steps, features and/or functions illustrated in FIGS. 1-18 may be rearranged and/or combined into a single component, step, feature or function or embodied in several components, steps, or functions. Additional elements, components, steps, and/or functions may also be added without departing from novel features disclosed herein. The apparatus, devices, and/or components illustrated in FIGS. 1, 2, 3, 4, 5, 8, 9, 14, 15, and 17 may be configured to perform one or more of the methods, features, or steps escribed herein. The novel algorithms described herein may also be efficiently implemented in software and/or embedded in hardware.

It is to be understood that the specific order or hierarchy of steps in the methods disclosed is an illustration of example processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b, and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A first apparatus for communication, comprising:
a processing system configured to:
output a first indication of an inverse discrete Fourier transform (IDFT) size, the IDFT size being based on a power-of-two; and
output or obtain a first transmission based on the IDFT size.

2. The first apparatus of claim 1, wherein the first transmission comprises a block-filtered orthogonal frequency division multiplexing (BF-OFDM) signal based on the IDFT size.

3. The first apparatus of claim 1, wherein the processing system is further configured to:
generate the first transmission based on a circular shift, within a frequency allocation, of successive resource block inputs for an IDFT.

4. The first apparatus of claim 3, wherein symbol allocation within the frequency allocation is less than fifty percent.

5. The first apparatus of claim 3, wherein at least one of:
a size of each resource block of the successive resource block inputs is 12 subcarriers; or
a size of the frequency allocation is based on the IDFT size.

6. The first apparatus of claim 5, wherein the IDFT size is 32 subcarriers, 64 subcarriers, or 128 subcarriers.

7. The first apparatus of claim 1, wherein:
the first indication specifies a minimum IDFT size; and
the first transmission comprises a block-filtered orthogonal frequency division multiplexing (BF-OFDM) signal that is based on another IDFT size that is larger than the minimum IDFT size and further based on the power-of-two.

8. The first apparatus of claim 1, wherein the first indication specifies at least one of:
a minimum IDFT size;
a specific IDFT size to be used for multiple transmissions or receptions; or
a specific IDFT size to be used for the first transmission.

9. The first apparatus of claim 1, wherein:
the processing system is further configured to obtain a second indication of a capability of a second apparatus to support use of a configurable IDFT size; and
the first indication is output based on the second indication.

10. The first apparatus of claim 1, further comprising:
a transceiver configured to transmit the first indication and transmit or receive the first transmission,
wherein the first apparatus is configured as a network entity.

11. A method for communication at a wireless node, the method comprising:
outputting a first indication of an inverse discrete Fourier transform (IDFT) size, the IDFT size being based on a power-of-two; and
outputting or obtaining a first transmission based on the IDFT size.

12. A first apparatus for communication, comprising:
a processing system configured to:
obtain a first indication of an inverse discrete Fourier transform (IDFT) size, the IDFT size being based on a power-of-two; and
obtain or output a first transmission based on the IDFT size.

13. The first apparatus of claim 12, wherein the first transmission comprises a block-filtered orthogonal frequency division multiplexing (BF-OFDM) signal based on the IDFT size.

14. The first apparatus of claim 12, wherein the processing system is further configured to:
generate the first transmission based on a circular shift, within a frequency allocation, of successive resource block inputs for an IDFT.

15. The first apparatus of claim 14, wherein symbol allocation within the frequency allocation is less than fifty percent.

16. The first apparatus of claim 14, wherein at least one of:
a size of each resource block of the successive resource block inputs is 12 subcarriers; or
a size of the frequency allocation is based on the IDFT size.

17. The first apparatus of claim 16, wherein the IDFT size is 32 subcarriers, subcarriers, or 128 subcarriers.

18. The first apparatus of claim 12, wherein:
the first indication specifies a minimum IDFT size; and
the first transmission comprises a block-filtered orthogonal frequency division multiplexing (BF-OFDM) signal that is based on another IDFT size that is larger than the minimum IDFT size and further based on the power-of-two.

19. The first apparatus of claim 12, wherein the first indication specifies at least one of:
a minimum IDFT size;
a specific IDFT size to be used for multiple transmissions or receptions; or
a specific IDFT size to be used for the first transmission.

20. The first apparatus of claim 12, wherein:
the processing system is further configured to output a second indication of a capability of a second apparatus to support use of a configurable IDFT size; and
the first indication is obtained based on the second indication.
